(19) United States
(12) Patent Application Publication
(10) Pub. No.: US 2012/0084657 A1
(43) Pub. Date: Apr. 5, 2012

(54) PROVIDING CONTENT TO A USER FROM MULTIPLE SOURCES BASED ON INTEREST TAG(S) THAT ARE INCLUDED IN AN INTEREST CLOUD

(75) Inventors: Manish Ranade, Sunnyvale, CA (US); James Andrew Long, Santa Clara, CA (US); Amit Motgi, Santa Clara, CA (US)

(73) Assignee: YAHOO! INC., Sunnyvale, CA (US)

(21) Appl. No.: 12/894,461

(22) Filed: Sep. 30, 2010

(51) Int. Cl. G06F 3/00

(52) U.S. Cl. 715/733

(57) ABSTRACT

Techniques are described herein for providing content to a user from multiple sources based on interest tag(s) that are included in an interest cloud. An interest cloud is a tag cloud that includes interest tags, which correspond to respective interests of a user. An interest of a user is subject matter that is deemed to have a greater importance than other subject matter to the user based on information that pertains to the user. For example, an interest of a user may be derived from information in the user's emails, social update streams, web browsing history, a content element that is selected by the user, content that is received from a source that is selected by the user, etc. In another example, a user may designate subject matter as being an interest of the user.

### BACKGROUND OF THE INVENTION

1. Field of the Invention

The present invention relates to techniques for providing content to a user from multiple sources.

2. Background

In a computer networking environment (e.g., the Internet), users commonly access sites that are hosted by content providers, so that the users may receive content that is available via those sites. Users often have little control over which content they receive from content providers. For instance, some content providers provide the same content to every user who accesses their sites. Other content providers may allow users to enter keyword(s), which the content providers may use to determine which content to provide to the users. If a content provider is capable of providing content from other sources, the content provider may allow users to select the sources from which content is to be provided.

Techniques have been proposed to provide content that is more specifically tailored to users. For example, some content providers gather information regarding users each time the users visit sites that are hosted by the content providers. For instance, the content providers may categorize content that is available via their sites and then track which categories are accessed by the users, the frequency with which the users access those categories, etc. The content providers may use this information in an effort to determine which content is likely to interest the users. However, such techniques typical do not give users control over the content that they receive from content providers.

Thus, systems, methods, and computer program products are needed that address one or more of the aforementioned shortcomings of conventional techniques for providing content to a user.

### BRIEF SUMMARY OF THE INVENTION

Various approaches are described herein for, among other things, providing content to a user from multiple sources based on interest tag(s) that are included in an interest cloud. An interest cloud is a tag cloud that includes interest tags, which correspond to respective interests of a user. An interest of a user is subject matter that is deemed to have a greater importance than other subject matter to the user based on information that pertains to the user. For example, an interest of a user may be derived from information in the user's emails, social update streams, web browsing history, a content element that is selected by the user, content that is received from a source that is selected by the user, etc. In another example, a user may designate subject matter as being an interest of the user. For instance, if a user adds an interest tag to an interest cloud, subject matter that corresponds to the interest tag is said to be an interest of the user.

An example method is described for providing content to a user from multiple sources based on interest tag(s) that are included in an interest cloud. In accordance with this example method, first content is retrieved from first source(s). An interest cloud is generated that includes interest tags that correspond to respective key terms that are associated with the first content. Second content is provided to a user based on a subset of the interest tags that is selected by the user. The second content is aggregated from second sources that are selected by the user. Each interest tag in the subset corresponds to a respective interest of the user.

Another example method is described for providing content to a user from multiple sources based on interest tag(s) that are included in an interest cloud. In accordance with this example method, first content is retrieved from first source(s). An interest cloud is generated that includes interest tags that correspond to respective key terms that are associated with the first content. Second content that includes content streams is provided to a user based on a subset of the interest tags that is selected by the user. Each content stream is received from a respective second source that is selected by the user. The content streams are provided to the user in respective browser elements in a common page (e.g., web page). Each browser element enables the user to browse through the respective content stream. Each interest tag in the subset corresponds to a respective interest of the user.

An example system is described that includes a retrieval module, a cloud generator, and a content provider. The retrieval module is configured to retrieve first content from first source(s). The cloud generator is configured to generate an interest cloud that includes interest tags that correspond to respective key terms that are associated with the first content. The content provider is configured to provide second content to a user based on a subset of the interest tags that is selected by the user. The second content is aggregated from second sources that are selected by the user. Each interest tag in the subset corresponds to a respective interest of the user.

Another example system is described that includes a retrieval module, a cloud generator, and a content provider. The retrieval module is configured to retrieve first content from first source(s). The cloud generator is configured to generate an interest cloud that includes interest tags that correspond to respective key terms that are associated with the first content. The content provider is configured to provide second content that includes content streams to a user based on a subset of the interest tags that is selected by the user. Each content stream is received from a respective second source that is selected by the user. The content streams are provided to the user in respective browser elements in a common page. Each browser element enables the user to browse through the respective content stream. Each interest tag in the subset corresponds to a respective interest of the user.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example computer system in accordance with an embodiment described herein.

FIGS. 2-11 depict flowcharts of example methods of providing content to a user from multiple sources based on interest tag(s) that are included in an interest cloud in accordance with embodiments described herein.

FIGS. 12, 20, and 27 are block diagrams of example implementations of an interest cloud module shown in FIG. 1 in accordance with embodiments described herein.

FIGS. 13 and 21-23 show example interest clouds in accordance with embodiments described herein.

FIG. 14 depicts a flowchart of an example method of providing an interest cloud in accordance with an embodiment described herein.

FIG. 15 depicts a flowchart of an example method of changing a priority attribute of an interest tag in accordance with an embodiment described herein.

FIG. 16 depicts a flowchart of an example method of enabling a user to change a content attribute of an interest tag in accordance with an embodiment described herein.

FIG. 17 depicts a flowchart of an example method of selecting content based on content attributes of interest tags in accordance with an embodiment described herein.

FIG. 18 depicts a flowchart of an example method of adding an interest tag to an interest could in accordance with an embodiment described herein.

FIG. 19 depicts a flowchart of an example method of updating content that is provided to a user in accordance with an embodiment described herein.

FIG. 24 depicts a flowchart of an example method of adding a cumulative interest tag to an interest cloud in accordance with an embodiment described herein.

FIG. 25 depicts a flowchart of an example method of recommending an interest tag to a user in accordance with an embodiment described herein.

FIG. 26 depicts a flowchart of an example method of providing access to an interest cloud in accordance with an embodiment described herein.

FIG. 28 shows example content that may be provided to a user in accordance with an embodiment described herein.

FIGS. 29-31 depict example pages in accordance with embodiments described herein.

FIG. 32 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of providing content to a user from multiple sources based on interest tag(s) that are included in an interest cloud. An interest cloud is a tag cloud that includes interest tags, which correspond to respective interests of a user. An interest of a user is subject matter that is deemed to have a greater importance than other subject matter to the user based on information that pertains to the user. For example, an interest of a user may be derived from information in the user's emails, social update streams, web browsing history, a content element that is selected by the user, content that is received from a source that is selected by the user, etc. In another example, a user may designate subject matter as being an interest of the user. For instance, if a user adds an interest tag to an interest cloud, subject matter that corresponds to the interest tag is said to be an interest of the user.

An interest of a user is distinguishable from subject matter that is defined by keywords derived from web search results, for example, because such keywords are not based on information that pertains to the user. Rather, such keywords are based merely on their occurrence in the web search results. Although web search results typically are provided to a user in response to a search query that is received from that user, the web search results are not selected by the user, are not received from a source that is selected by the user, and do not otherwise pertain to the user.

Techniques described herein for providing content to a user from multiple sources based on interest tag(s) that are included in an interest cloud have a variety of benefits as compared to conventional techniques for providing content. For instance, the techniques described herein may give users control over the content that they receive from content providers. For example, users may select content from which interest tags are derived. In another example, interest tags may be derived from content that is received from sources that are selected by users. Users may add, delete, and/or modify interest tags in an interest cloud. Users may prioritize the interest tags and/or change priorities that are associated with the interest tags. Users may map each interest tag to a respective type of content (e.g., image, news, video, etc.). Each interest tag may indicate a source from which the interest tag is provided. Users may create relationships between interest tags to create cumulative interest tags. A relationship between interest tags may be based on a Boolean operator. Some examples of a Boolean operator include but are not limited to AND, OR, NAND, NOR, etc.

The techniques may enable a user to view a substantial amount of content that relates to the user's demographic, historical activity, and/or interests from multiple sources (e.g., social networks) at once. Content may be provided to a user as an aggregated content stream that includes content elements from the various sources or as distinct content streams with each content stream including content elements that are received from a respective source. Content that is provided to a user may be persistent throughout the user's experience. For instance, the user may be able to browse through the content as the user views designated content elements that correspond to links that the user selects in the content. Content may be updated in real-time when a change is made to an interest tag upon which the content is based. Example embodiments are capable of recommending interest tags and/or relationships between interest tags to a user.

### II. Example Embodiments

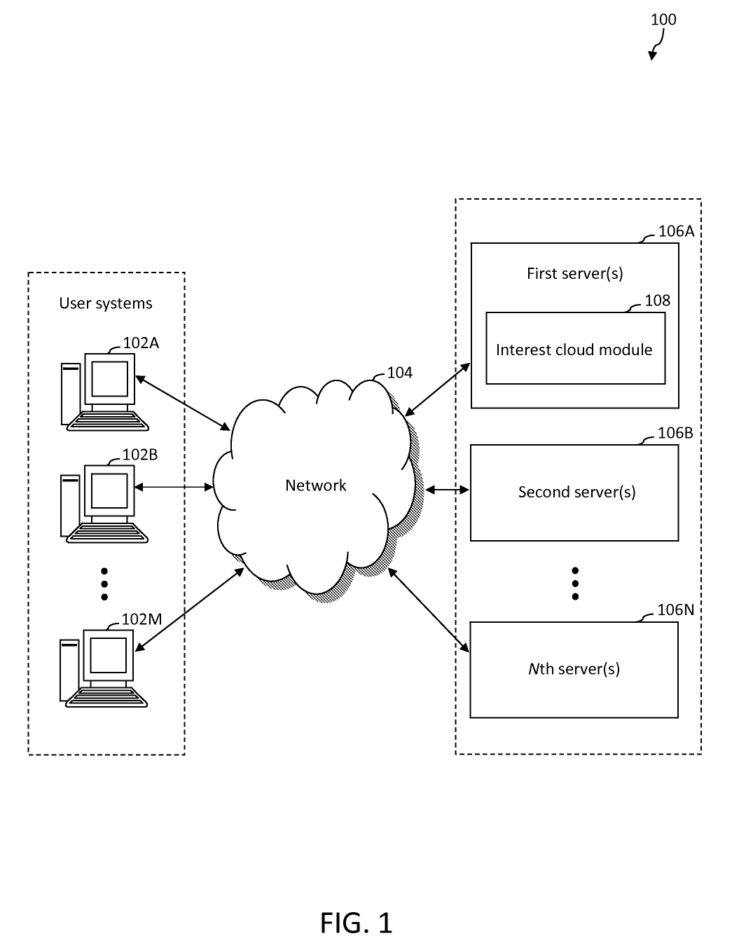

FIG. 1 is a block diagram of an example computer system 100 in accordance with an embodiment described herein. Generally speaking, computer system 100 operates to provide content to users in response to requests (e.g., hypertext transfer protocol (HTTP) requests) that are provided by the users. The content may include web pages, images, videos, other types of files, output of executables, etc. and/or links thereto. In accordance with example embodiments, computer system 100 is configured to provide content to a user from multiple sources based on interest tag(s) that are included in an interest cloud.

As shown in FIG. 1, computer system 100 includes a plurality of user systems 102A-102M, a network 104, and a plurality of servers 106A-106N. Communication among user systems 102A-102M and servers 106A-106N is carried out over network 104 using well-known network communication protocols. Network 104 may be a wide-area network (e.g., the Internet), a local area network (LAN), another type of network, or a combination thereof.

User systems 102A-102M are computers or other processing systems, each including one or more processors, that are capable of communicating with servers 106A-106N. User systems 102A-102M are capable of accessing sites (e.g., web sites) hosted by servers 104A-104N, so that user systems 102A-102M may access content that is available via the sites. User systems 102A-102M are configured to provide requests (e.g., hypertext transfer protocol (HTTP) requests) to servers 106A-106N for requesting content stored on (or otherwise accessible via) servers 106A-106N. For instance, a user may initiate a request for content using a client (e.g., a web crawler, a web browser, a non-web-enabled client, etc.) deployed on a user system 102 that is owned by or otherwise accessible to the user.

Servers 106A-106N are computers or other processing systems, each including one or more processors, that are capable of communicating with user systems 102A-102M. Servers 106A-106N are configured to host respective sites (e.g., web sites), so that the sites are accessible to users of computer system 100. Servers 106A-106N are further configured to provide content to users in response to receiving requests (e.g., HTTP requests) from the users.

First server(s) 106A includes an interest cloud module 108. Interest cloud module 108 is configured to retrieve content from source(s). For instance, the content may be stored on first server(s) 106A, on a user system 102 of the user, and/or elsewhere. Content may include web pages, images, videos, other types of files, output of executables, etc. and/or links thereto. Each web page, image, video, etc. is referred to as a content element. Examples of a source from which the content may be retrieved include but are not limited to a web site (e.g., a blog), a social update stream of a user or of a person who is included in an affinity set of the user, a search click log of the user, a newsfeed, a network with which the user is associated (e.g., a social network), etc. A social update stream is essentially a list of social updates, which are generated in response to interactions of one or more users who belong to a given affinity set. A user's interactions may be with content or another one or more members of the affinity set. For example, an affinity set may be any group of persons, including a group of friends, business associates, players of a massively multiplayer online game, persons with a common interest, all users of a social network, application (“app”), or web site, or a subgroup thereof. Persons who are included in an affinity set of a user are often referred to as “connections” of the user. A user may belong to any number of affinity sets. A search click log is a record of search queries that are provided by a user and the content elements that are selected by the user from the search results that are retrieved in response to those search queries.

Interest cloud module 108 is further configured to generate an interest cloud that includes interest tags that correspond to respective key terms (e.g., keywords and/or key phrases) that are associated with the content that is retrieved from the source(s). The interest cloud may be interactive, such that a user is allowed to edit the interest cloud. For instance, interest cloud module 108 may add interest tags to the interest cloud, delete interest tags from the interest cloud, and/or modify interest tags that are included in the interest cloud based on instructions received from a user system 102 that is owned by or otherwise accessible to the user.

Interest cloud module 108 may determine key terms that are associated with the content using any suitable technique. For example, interest cloud 108 may determine key terms that are associated with content from sources such as Flickr®, Delicious™, and YouTube® based on metadata that is associated with the content. Content that is received from the aforementioned sources may be image(s), social bookmark(s), or video(s), respectively.

In another example, interest cloud 108 may determine key terms that are associated with a uniform resource identifier (URI), such as a uniform resource locator (URL) or a uniform resource name (URN), based on a key term analysis of the text (e.g., in a web page) that is identified by the URI. In accordance with this example, interest cloud module 108 may analyze the text using a keyword analysis technique to determine the key terms that are most commonly recited in the text.

In yet another example, interest cloud module 108 may determine key terms that are associated with content from sources such as LinkedIn°, Twitter®, Facebook®, Associated Content®, Yahoo!® Buzz™, Google® News, a technical gossip web site, and a celebrity gossip web site based on a key term analysis of such content. Content that is received from such sources may include social updates from a user's social update stream, blog posts, news articles, etc.

Interest cloud module 108 may generate the interest cloud to include interest tags in addition to the aforementioned interest tags that correspond to the respective key terms that are associated with the content that is retrieved from the source(s). For example, the interest cloud may include interest tags that are based on interest indicators that are received from a user via a respective user system 102. In accordance with this example, the interest indicators specify respective interests of the user.

Interest cloud module 108 is further configured to provide content to a user based on a subset of the interest tags that is selected by the user. Each interest tag in the subset corresponds to a respective interest of the user. The content that is provided to the user may be the same as or different from the content that is retrieved from the source(s) for purposes of generating the interest cloud.

In accordance with a first example embodiment, the content that is provided to the user is aggregated from multiple sources that are selected by the user. For example, content elements from the sources may be interleaved to provide one or more content streams to the user.

In accordance with a second example embodiment, the content that is provided to the user includes multiple content streams. Each content stream is received from a respective source that is selected by the user. The content streams are provided to the user in respective browser elements. The browser elements are included in a common page (e.g., web page). Each browser element enables the user to browse through a respective content stream.

First server(s) 106A is shown to include interest cloud module 108 for illustrative purposes. It will be recognized that any one or more of servers 106A-106N may include an interest cloud module, such as interest cloud module 108. It will be further recognized that any one or more user systems 102A-102M may communicate with any one or more servers 106A-106N. Although user systems 102A-102M are depicted as desktop computers in FIG. 1, persons skilled in the relevant art(s) will appreciate that user systems 102A-102M may include any client-enabled system or device, including but not limited to a laptop computer, a tablet computer, a personal digital assistant, a cellular telephone, etc. It will be recognized that although some operations are described herein as being performed by a user for ease of discussion, such operations may be performed by a respective user system 102 or by interest cloud module 108 in response to an instruction that is received from the user.

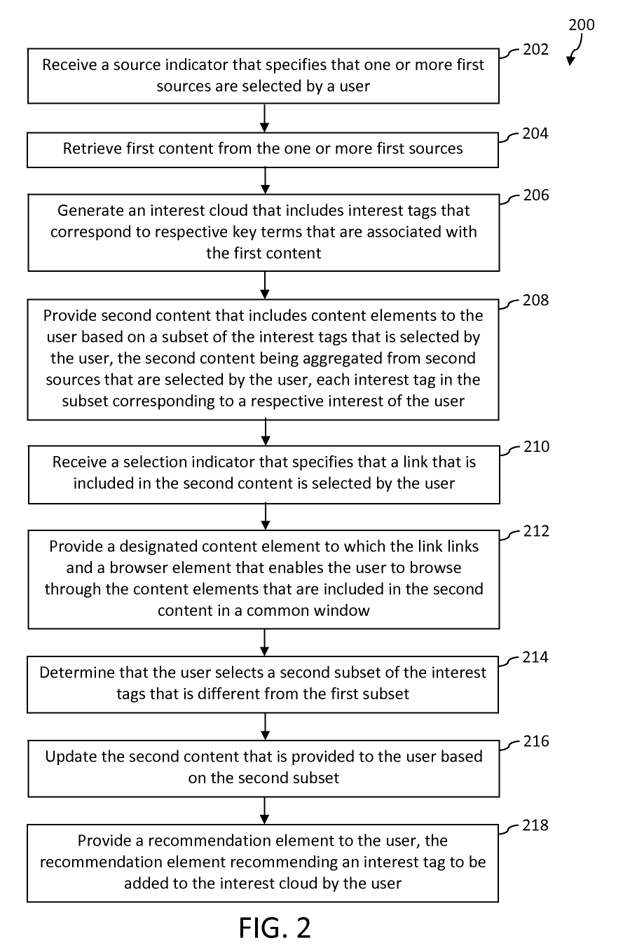

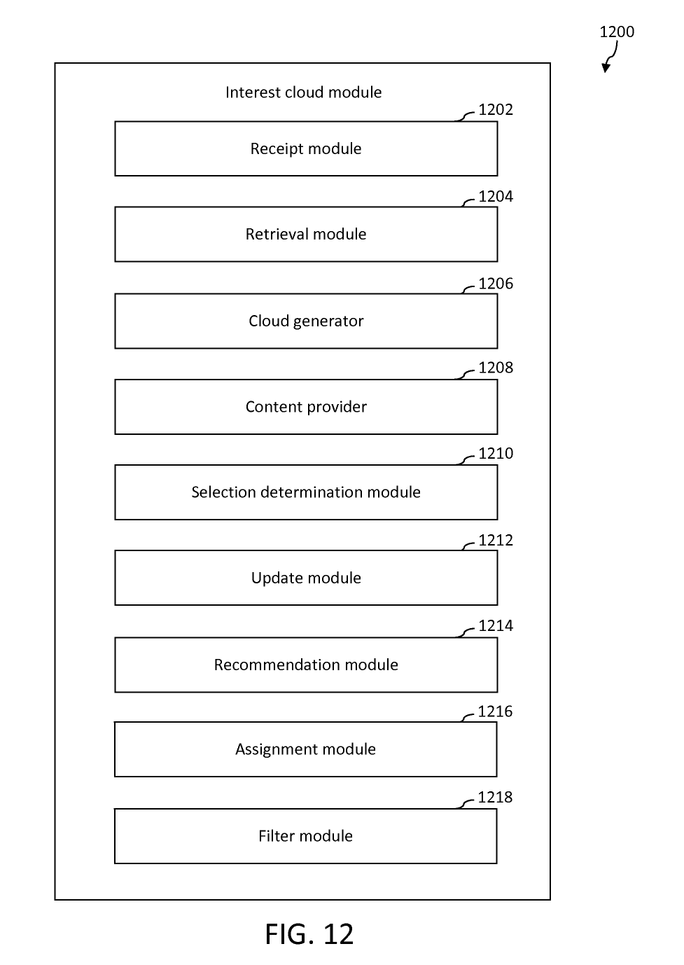

FIGS. 2-11 depict flowcharts 200, 300, 400, 500, 600, 700, 800, 900, 1000, and 1100 of example methods of providing content to a user from multiple sources based on interest tag(s) that are included in an interest cloud in accordance with embodiments described herein. Flowcharts 200, 300, 400, 500, 600, 700, 800, 900, 1000, and 1100 may be performed by interest cloud module 108 of computer system 100 shown in FIG. 1, for example. For illustrative purposes, flowcharts 200, 300, 400, 500, 600, 700, 800, 900, 1000, and 1100 are described with respect to an interest cloud module 1200 shown in FIG. 12, which is an example of an interest cloud module 108, according to an embodiment. As shown in FIG. 12, interest cloud module 1200 includes a receipt module 1202, a retrieval module 1204, a cloud generator 1206, a content provider 1208, a selection determination module 1210, an update module 1212, a recommendation module 1214, an assignment module 1216, and a filter module 1218. Further structural and operational embodiments will be apparent to persons skilled in the relevant art(s) based on the discussion regarding flowcharts 200, 300, 400, 500, 600, 700, 800, 900, 1000, and 1100.

As shown in FIG. 2, the method of flowchart 200 begins at step 202. In step 202, a source indicator is received that specifies that one or more first sources are selected by a user. Examples of a source include but are not limited to a web site (e.g., a blog), a social update stream of a user or of a person who is included in an affinity set of the user, a search click log of the user, a newsfeed, a network with which the user is associated (e.g., a social network of which the user is a member), etc. In an example implementation, receipt module 1202 receives the source indicator. For example, receipt module 1202 may interpret the source indicator to determine that the one or more first sources are selected by the user.

At step 204, first content is retrieved from the one or more first sources. Content may include web pages, images, videos, other types of files, output of executables, etc. and/or links thereto. Each web page, image, video, etc. is referred to as a content element. In an example implementation, retrieval module 1204 retrieves the first content from the one or more sources.

At step 206, an interest cloud is generated. The interest cloud includes interest tags that correspond to respective key terms that are associated with the first content. The interest cloud may be generated based on demographic information regarding the user, though the scope of the example embodiments is not limited in this respect. In an example implementation, cloud generator 1206 generates the interest cloud.

In one aspect, any one or more of the key terms may be included in metadata that is associated with an image, a video, a social bookmark, etc. that is included in the first content. In accordance with this aspect, cloud generator 1206 may review the metadata to determine the key term(s) therein.

In another aspect, any one or more of the key terms may be included in a social update element that is included in a social update stream that is included in the first content. Such a social update stream may be a social update stream of the user or a social update stream of a person who is included in an affinity set of the user. In accordance with this aspect, cloud generator 1206 may review the social update element to determine the key term(s) therein.

In an example embodiment, the interest cloud is generated to include interest tags in addition to the aforementioned interest tags that correspond to the respective key terms that are associated with the first content. For instance, the interest cloud may include at least one interest tag that is based on an interest indicator that is received from the user. Such an interest indicator specifies an interest of the user.

In another example embodiment, the interest cloud is interactive, such that the user is allowed to edit the interest cloud. For instance, update module 1212 may add interest tags to the interest cloud, delete interest tags from the interest cloud, and/or modify interest tags that are included in the interest cloud based on instructions that are received from the user. Some techniques for editing an interest cloud are described in greater detail in section III below with reference to FIGS. 13-27.

At step 208, second content that includes content elements is provided to the user based on a subset of the interest tags that is selected by the user. The second content may be provided to the user further based on demographic information regarding the user and/or historical activity of the user with respect to at least one social network, though the scope of the example embodiments is not limited in this respect. The second content is aggregated from second sources that are selected by the user. For example, the second content may be aggregated from content streams that are received from the respective second sources. In accordance with this example, each of the content streams may include most popular content elements that correspond to the subset of the interest tags with respect to the respective second source. In another example, at least some of the content elements that are included in the second content may be included in the first content. Each interest tag in the subset corresponds to a respective interest of the user. In an example implementation, content provider 1208 provides the second content to the user.

At step 210, a selection indicator is received. The selection indicator specifies that a link that is included in the second content is selected by the user. In an example implementation, receipt module 1202 receives the selection indicator. For example, receipt module 1202 interprets the selection indicator to determine that the link that is included in the second content is selected by the user.

At step 212, a designated content element and a browser element are provided in a common page. The link links to the designated content element. The browser element enables the user to browse through the content elements that are included in the second content. In an example implementation, content provider 1208 provides the designated content element and the browser element in the common page.

At step 214, a determination is made that the user selects a second subset of the interest tags that is different from the first subset. In an example implementation, selection determination module 1210 determines that the user selects the second subset of the interest tags.

At step 216, the second content that is provided to the user is updated based on the second subset. For example, the second content that is provided to the user may be updated in substantially real-time in response to determining that the user selects the second subset. In an example implementation, update module 1212 updates the second content that is provided to the user based on the second subset.

At step 218, a recommendation element is provided to the user. The recommendation element recommends an interest tag to be added to the interest cloud by the user. The recommendation element may be provided to the user based on any suitable factor(s), including but not limited to demographic information regarding the user and/or historical activity of the user with respect to at least one social network. The user may accept the recommended interest tag in any of a variety of ways to initiate inclusion of the recommended interest tag in the interest cloud. For example, the user may press a virtual “OK” button to accept the recommended interest tag. For instance, the virtual “OK” button may be included in the recommendation element. In another example, the user may type, paste, or otherwise enter a character string or other identifier that is associated with the interest tag (e.g., a name of the interest tag) in an interface element to accept the recommended interest tag. In an example implementation, recommendation module 1214 provides the recommendation element to the user.

In some example embodiments, one or more steps 202, 204, 206, 208, 210, 212, 214, 216, and/or 218 of flowchart 200 may not be performed. Moreover, steps in addition to or in lieu of steps 202, 204, 206, 208, 210, 212, 214, 216, and/or 218 may be performed.

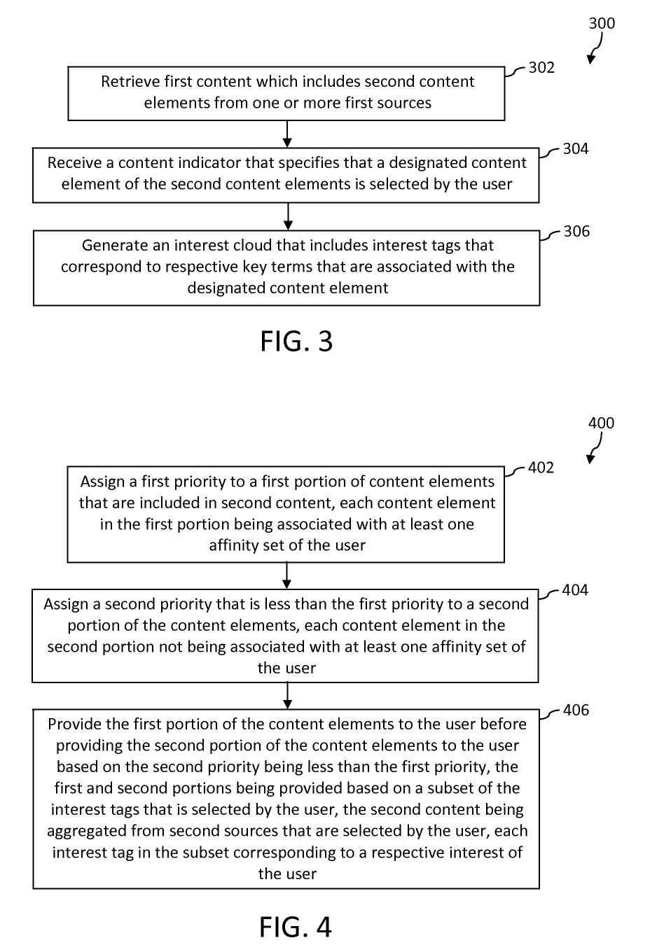

In an example embodiment, instead of performing steps 202, 204, and 206 of flowchart 200, the steps of flowchart 300 in FIG. 3 are performed. In another example embodiment, instead of performing steps 204 and 206 of flowchart 200, the steps of flowchart 300 in FIG. 3 are performed. As shown in FIG. 3, the method of flowchart 300 begins at step 302. In step 302, first content is retrieved. The first content includes second content elements from one or more first sources. In an example implementation, retrieval module 1204 retrieves the first content from the one or more first sources.

At step 304, a content indicator is received. The content indicator specifies that a designated content element of the second content elements is selected by the user. In an example implementation, receipt module 1202 receives the content indicator. For example, receipt module 1202 may interpret the content indicator to determine that the designated content element of the second content elements is selected by the user.

At step 306, an interest cloud is generated. The interest cloud includes interest tags that correspond to respective key terms that are associated with the designated content element. In an example implementation, cloud generator 1206 generates the interest cloud.

In an example embodiment, instead of performing step 208 of flowchart 200, the steps of flowchart 400 in FIG. 4 are performed. As shown in FIG. 4, the method of flowchart 400 begins at step 402. In step 402, a first priority is assigned to a first portion of content elements that are included in second content. Each content element in the first portion is associated with at least one affinity set of the user. In an example implementation, assignment module 1216 assigns the first priority to the first portion of the content elements that are included in the second content.

At step 404, a second priority that is less than the first priority is assigned to a second portion of the content elements. Each content element in the second portion is not associated with at least one affinity set of the user. In an example implementation, assignment module 1216 assigns the second priority to the second portion of the content elements.

At step 406, the first portion of the content elements is provided to the user before the second portion of the content elements is provided to the user based on the second priority being less than the first priority. The first and second portions are provided based on a subset of the interest tags that is selected by the user. The second content is aggregated from second sources that are selected by the user. Each interest tag in the subset corresponds to a respective interest of the user. In an example implementation, content provider 1208 provides the first portion of the content elements to the user before content provider 1208 provides the second portion of the content elements to the user based on the second priority being less than the first priority.

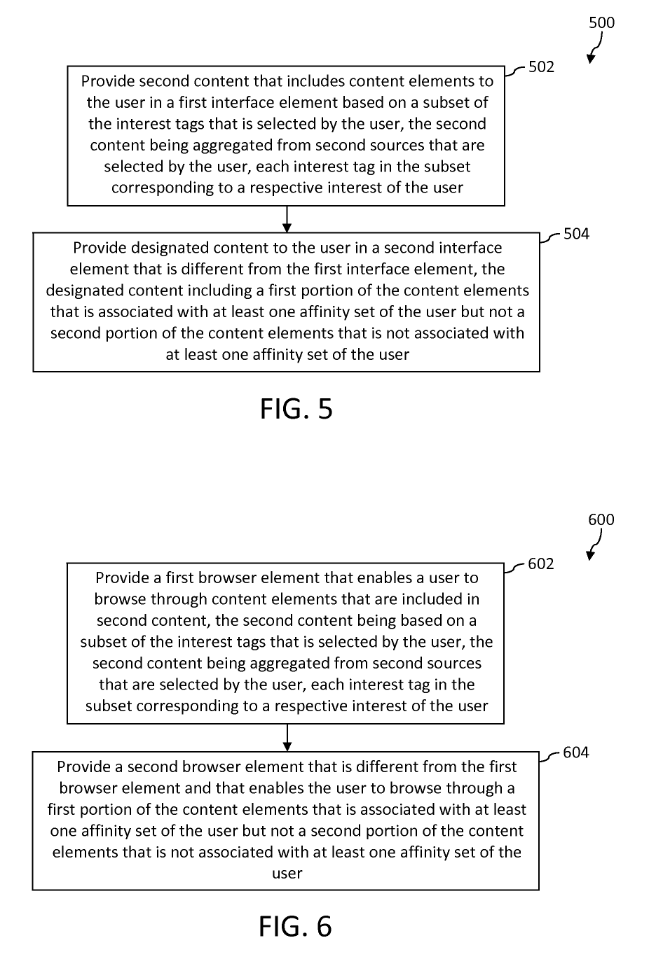

In another example embodiment, instead of performing step 208 of flowchart 200, the steps of flowchart 500 in FIG. 5 are performed. As shown in FIG. 5, the method of flowchart 500 begins at step 502. In step 502, second content that includes content elements is provided to the user in a first interface element based on a subset of the interest tags that is selected by the user. The second content is aggregated from second sources that are selected by the user. Each interest tag in the subset corresponds to a respective interest of the user. In an example implementation, content provider 1208 provides the second content to the user in the first interface element based on the subset of the interest tags that is selected by the user.

At step 504, designated content is provided to the user in a second interface element that is different from the first interface element. The designated content includes a first portion of the content elements that is associated with at least one affinity set of the user but not a second portion of the content elements that is not associated with at least one affinity set of the user. In an example implementation, content provider 1208 provides the designated content to the user in the second interface element.

In yet another example embodiment, instead of performing step 208 of flowchart 200, the steps of flowchart 600 in FIG. 6 are performed. As shown in FIG. 6, the method of flowchart 600 begins at step 602. In step 602, a first browser element is provided. The first browser element enables a user to browse through content elements that are included in second content. The second content is based on a subset of the interest tags that is selected by the user. The second content is aggregated from second sources that are selected by the user. Each interest tag in the subset corresponds to a respective interest of the user. In an example implementation, content provider 1208 provides the first browser element.

At step 604, a second browser element that is different from the first browser element is provided. The second browser element enables the user to browse through a first portion of the content elements that is associated with at least one affinity set of the user but not a second portion of the content elements that is not associated with at least one affinity set of the user. In an example implementation, content provider 1208 provides the second browser element.

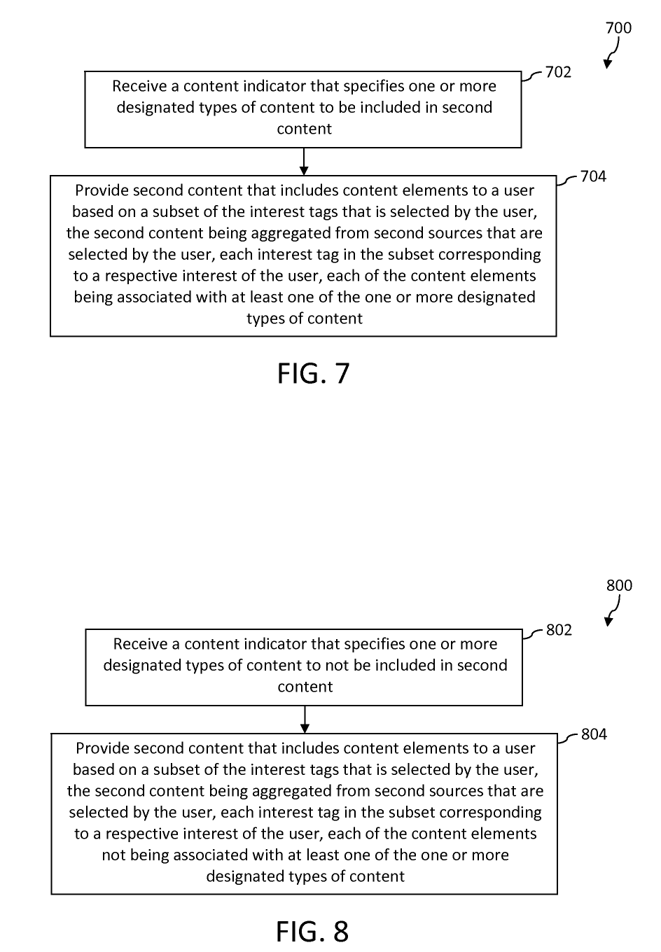

In still another example embodiment, instead of performing step 208 of flowchart 200, the steps of flowchart 700 in FIG. 7 are performed. As shown in FIG. 7, the method of flowchart 700 begins at step 702. In step 702, a content indicator is received. The content indicator specifies one or more designated types of content to be included in second content. In an example implementation, receipt module 1202 receives the content indicator. For example, receipt module 1202 may interpret the content indicator to determine that the one or more designated types of content are to be included in the second content.

At step 704, second content that includes content elements is provided to a user based on a subset of the interest tags that is selected by the user. The second content is aggregated from second sources that are selected by the user. Each interest tag in the subset corresponds to a respective interest of the user. Each of the content elements is associated with at least one of the one or more designated types of content. In an example implementation, content provider 1208 provides the second content to the user based on the subset of the interest tags that is selected by the user.

In yet another example embodiment, instead of performing step 208 of flowchart 200, the steps of flowchart 800 in FIG. 8 are performed. As shown in FIG. 8, the method of flowchart 800 begins at step 802. In step 802, a content indicator is received. The content indicator specifies one or more designated types of content to not be included in second content. In an example implementation, receipt module 1202 receives the content indicator. For example, receipt module 1202 may interpret the content indicator to determine that the one or more designated types of content are not to be included in the second content.

At step 804, second content that includes content elements is provided to a user based on a subset of the interest tags that is selected by the user. The second content is aggregated from second sources that are selected by the user. Each interest tag in the subset corresponds to a respective interest of the user. Each of the content elements is not associated with at least one of the one or more designated types of content. In an example implementation, content provider 1208 provides the second content to the user based on the subset of the interest tags that is selected by the user.

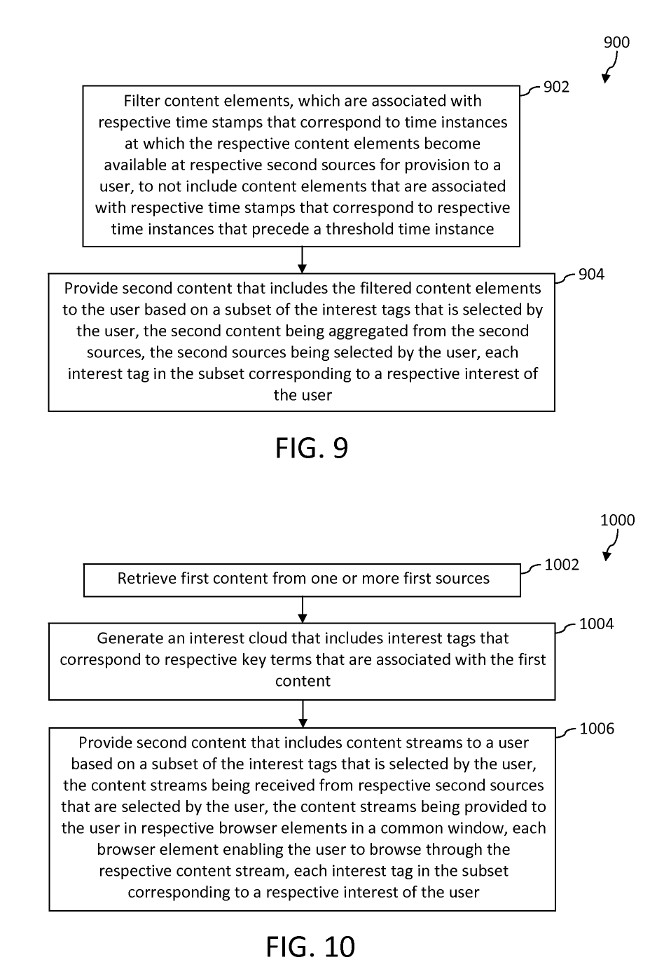

In still another example embodiment, instead of performing step 208 of flowchart 200, the steps of flowchart 900 in FIG. 9 are performed. As shown in FIG. 9, the method of flowchart 900 begins at step 902. In step 902, content elements, which are associated with respective time stamps that correspond to time instances at which the respective content elements become available at respective second sources for provision to a user, are filtered to not include content elements that are associated with respective time stamps that correspond to respective time instances that precede a threshold time instance. In an example, filter module 1218 filters the content elements to not include content elements that are associated with respective time stamps that correspond to respective time instances that precede the threshold time instance.

At step 904, second content that includes the filtered content elements is provided to the user based on a subset of the interest tags that is selected by the user. The second content is aggregated from the second sources. The second sources are selected by the user. Each interest tag in the subset corresponds to a respective interest of the user. In an example implementation, content provider 1208 provides the second content to the user based on the subset of the interest tags that is selected by the user.

As shown in FIG. 10, the method of flowchart 1000 begins at step 1002. In step 1002, first content is retrieved from one or more first sources. In an example implementation, retrieval module 1204 retrieves the first content from the one or more first sources.

At step 1004, an interest cloud is generated. The interest cloud includes interest tags that correspond to respective key terms that are associated with the first content. In an example implementation, cloud generator 1206 generates the interest cloud.

At step 1006, second content that includes content streams is provided to a user based on a subset of the interest tags that is selected by the user. The content streams are received from respective second sources that are selected by the user. The content streams are provided to the user in respective browser elements in a common page. Each browser element enables the user to browse through the respective content stream. Each interest tag in the subset corresponds to a respective interest of the user. In an example implementation, content provider 1208 provides the second content to the user based on the subset of the interest tags that is selected by the user.

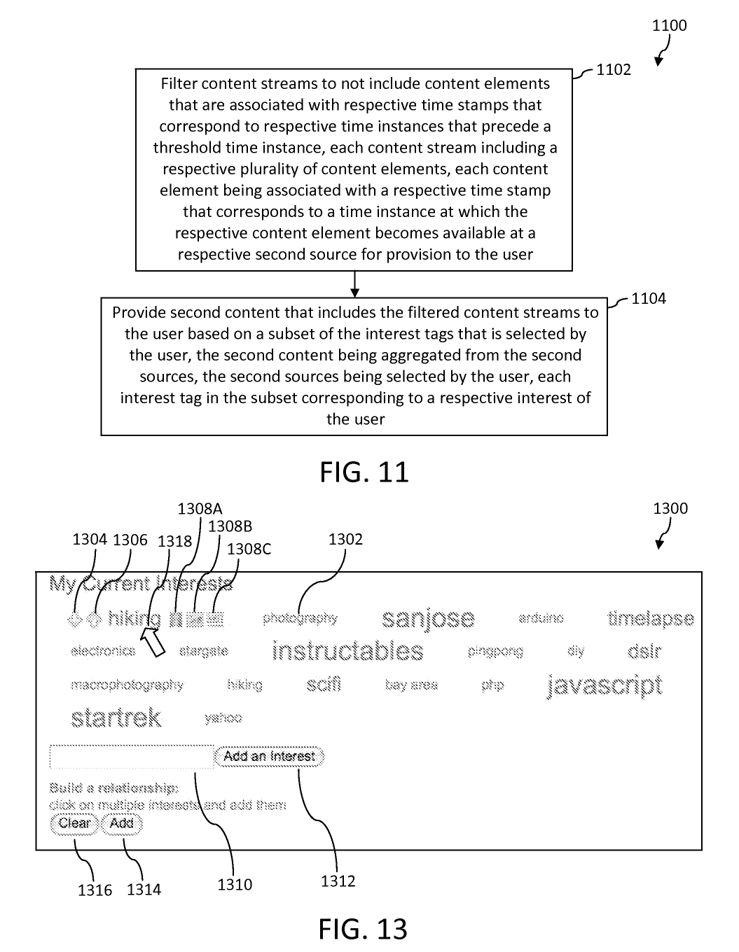

In an example embodiment, instead of performing step 1006 of flowchart 1000, the steps of flowchart 1100 in FIG. 11 are performed. As shown in FIG. 11, the method of flowchart 1100 begins at step 1102. In step 1102, content streams are filtered to not include content elements that are associated with respective time stamps that correspond to respective time instances that precede a threshold time instance. Each content stream includes a respective plurality of content elements. Each content element is associated with a respective time stamp that corresponds to a time instance at which the respective content element becomes available at a respective second source for provision to the user. In an example implementation, filter module 1218 filters the content streams to not include elements that are associated with respective time stamps that correspond to respective time instances that precede the threshold time instance.

At step 1104, second content that includes the filtered content streams is provided to the user based on a subset of the interest tags that is selected by the user. The second content is aggregated from the second sources. The second sources are selected by the user. Each interest tag in the subset corresponds to a respective interest of the user. In an example implementation, content provider 1208 provides the second content to the user based on the subset of the interest tags that is selected by the user.

It will be recognized that interest cloud module 1200 may not include one or more of receipt module 1202, retrieval module 1204, cloud generator 1206, content provider 1208, selection determination module 1210, update module 1212, recommendation module 1214, assignment module 1216, and/or filter module 1218. Furthermore, interest cloud module 1200 may include modules in addition to or in lieu of receipt module 1202, retrieval module 1204, cloud generator 1206, content provider 1208, selection determination module 1210, update module 1212, recommendation module 1214, assignment module 1216, and/or filter module 1218.

### III. Other Example Embodiments

FIG. 13 shows an example interest cloud 1300 in accordance with an embodiment described herein. For instance, interest cloud 1300 may be provided to a user via a browser that is installed on a user system (e.g., any of user systems 102A-102M). As shown in FIG. 13, interest cloud 1300 includes a plurality of interest tags 1302. The interest tags 1302 are respectively labeled as “hiking”, “photography”, “sanjose”, and so on. Each interest tag may be associated with one or more attributes. Examples of attributes include but are not limited to a priority of an interest tag, a type of content that is associated with the interest tag, a source of the interest tag, whether the interest tag is flagged for publication to other users, etc.

In FIG. 13, a cursor 1318 is positioned proximate the “hiking” interest tag for illustrative purposes, causing indicators 1304, 1306, and 1308A-1308C to appear. Each of indicators 1304, 1306, and 1308A-1308C is associated with a respective attribute of the “hiking” interest tag. For instance, indicators 1304 and 1306 are associated with a priority attribute of the “hiking” interest tag. Accordingly, indicators 1304 and 1306 are referred to as priority indicators. Priority indicators 1304 and 1306 may be used to change a priority that is associated with the “hiking” interest tag. Priority indicator 1304 is shown as an upward arrow for illustrative purposes. A user may select (e.g., click on) priority indicator 1304 to increase the priority of the “hiking” interest tag. Priority indicator 1306 is shown as a downward arrow for illustrative purposes. The user may select priority indicator 1306 to decrease the priority of the “hiking” interest tag.

Indicators 1308A-1308C are associated a content attribute of the “hiking” interest tag. Accordingly, indicators 1308A-1308C are referred to as content indicators. Content indicators 1308A-1308C may be used to associate the “hiking” interest tag with designated types of content. Content indicators 1308A-1308C correspond to video content, image content, and news content, respectively. The “hiking” interest tag is shown to be associated with three types of content—video content, image content, and news content—for illustrative purposes and is not intended to be limiting. For example, the “hiking” interest tag may not be associated with one or more of video content, image content, and/or news content. In another example, the “hiking” interest tag may be associated with other type(s) of content in lieu of or in addition to video content, image content, and/or news content.

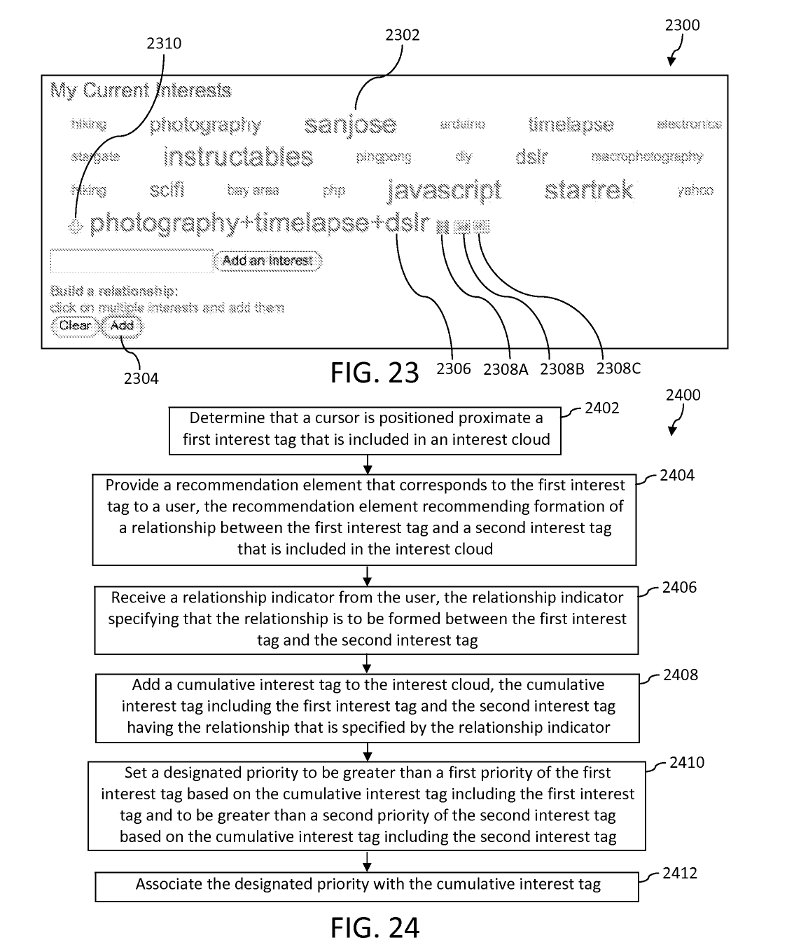

A user may type an interest into entry element 1310 and select add button 1312 to add an interest tag that corresponds to the interest to the interest cloud 1300. Add button 1314 and clear button 1316 may be used for creating a cumulative interest tag that includes two or more of the interest tags 1302. Further description of the functionality associated with buttons 1314 and 1316 is provided below with reference to FIGS. 22 and 23.

A user may delete an interest tag from interest cloud 1300 in any of a variety of ways. For example, the user may “right-click” the interest tag to access a drop-down, pop-up, or equivalent menu, or other graphical interface element from which the user may select a “delete” indicator. In another example, the user may place cursor 1318 proximate a designated portion (e.g., right side, left side, top, bottom, etc.) of the interest tag to cause a “delete” indicator to be displayed. In either example, the user may select the “delete” indicator to initiate deletion of the interest tag from the interest cloud 1300.

In FIG. 13, cursor 1318 is shown to overlap the “hiking” interest tag. It will be recognized, however, that cursor 1318 need not necessarily overlap a tag in order for cursor 1318 to be positioned proximate the tag. Moreover, priority indicators 1304 and 1306 and content indicators 1308A-1308C are shown in FIG. 13 for illustrative purposes and are not intended to be limiting. It will be recognized that any suitable types of indicators, corresponding to any suitable attributes, may be provided with respect to an interest tag to enable a user to control values of those attributes.

It will be recognized that a user need not necessarily position a cursor proximate an interest tag in order for attributes of the interest tag to be determined. For example, the interest tag may be configured to indicate one or more of its attributes without the need for an action by the user.

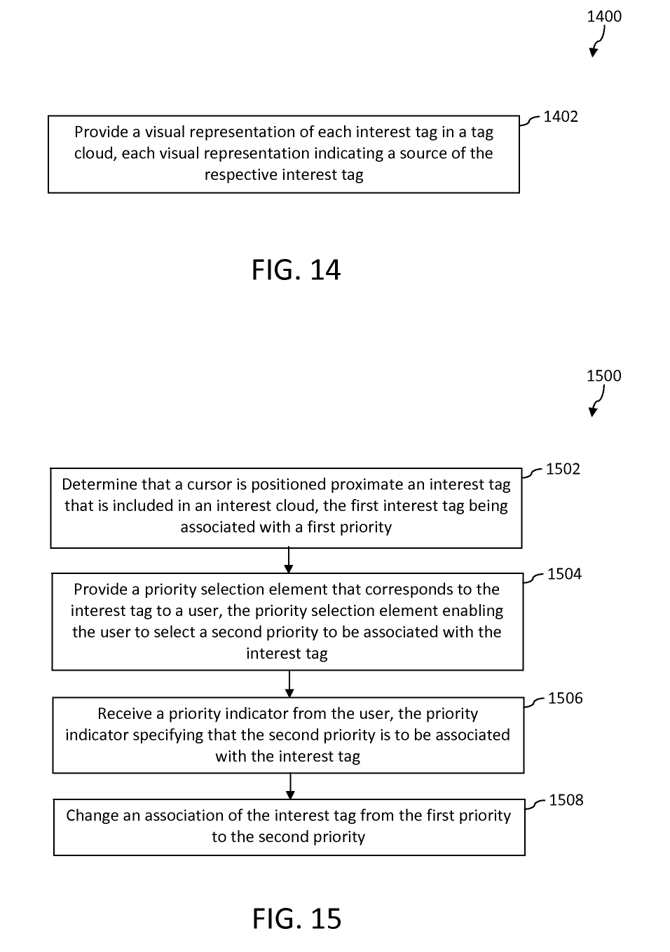

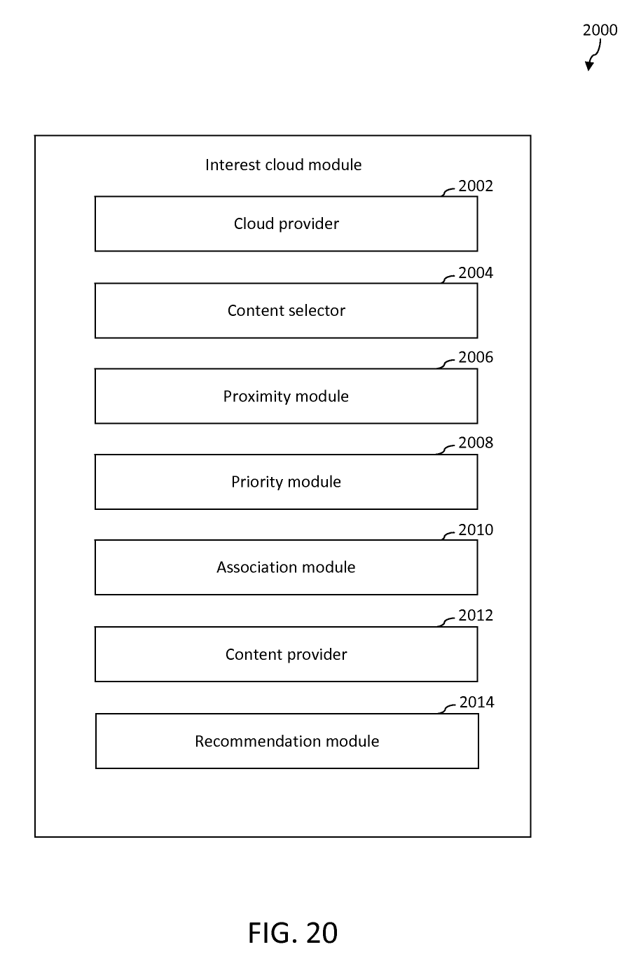

FIGS. 14-19, and 24 depict flowcharts 1400, 1500, 1600, 1700, 1800, 1900, and 2400 of example methods in accordance with embodiments described herein. Flowcharts 1400, 1500, 1600, 1700, 1800, 1900, and 2400 may be performed by interest cloud module 108 of computer system 100 shown in FIG. 1, for example. For illustrative purposes, flowcharts 1400, 1500, 1600, 1700, 1800, 1900, and 2400 are described with respect to an interest cloud module 2000 shown in FIG. 20, which is an example of an interest cloud module 108, according to an embodiment. As shown in FIG. 20, interest cloud module 2000 includes a cloud provider 2002, a content selector 2004, a proximity module 2006, a priority module 2008, an association module 2010, a content provider 2012, and a recommendation module 2014. Further structural and operational embodiments will be apparent to persons skilled in the relevant art(s) based on the discussion regarding flowcharts 1400, 1500, 1600, 1700, 1800, 1900, and 2400.

FIG. 14 depicts a flowchart 1400 of an example method of providing an interest cloud in accordance with an embodiment described herein. As shown in FIG. 14, the method of flowchart 1400 includes step 1402. At step 1402, a visual representation of each interest tag in the interest cloud is provided. Each visual representation indicates a source of the respective interest tag. For example, each visual representation may be associated with a respective color to indicate the source of the respective interest tag. In accordance with this example, each source may correspond to a different color. In another example, each visual representation may be associated with a respective icon (or type of icon). In accordance with this example, each source may correspond to a different icon or type thereof. A source is one example attribute that an interest tag may have. It will be recognized that each visual representations may indicate any suitable attribute(s) in addition to or in lieu of the source of the respective interest tag. In an example implementation, cloud provider 2002 provides the visual representation of each interest tag.

FIG. 15 depicts a flowchart 1500 of an example method of changing a priority attribute of an interest tag in accordance with an embodiment described herein. As shown in FIG. 15, the method of flowchart 1500 begins at step 1502. In step 1502, a determination is made that a cursor is positioned proximate an interest tag that is included in an interest cloud. The interest tag is associated with a first priority. In an example implementation, proximity module 2006 determines that the cursor is positioned proximate the interest tag. In some example embodiments, step 1502 need not necessarily be performed.

At step 1504, a priority selection element that corresponds to the interest tag is provided to a user. The priority selection element enables the user to select a second priority to be associated with the interest tag. In an example implementation, priority module 2008 provides the priority selection element that corresponds to the interest tag to the user.

At step 1506, a priority indicator is received from the user. The priority indicator specifies that the second priority is to be associated with the interest tag. In an example implementation, association module 2010 receives the priority indicator from the user.

At step 1508, an association of the interest tag is changed from the first priority to the second priority. Accordingly, it may be said that a priority attribute of the interest tag is changed to indicate that the interest tag is associated with the second priority. In an example implementation, association module 2010 changes the association of the interest tag from the first priority to the second priority.

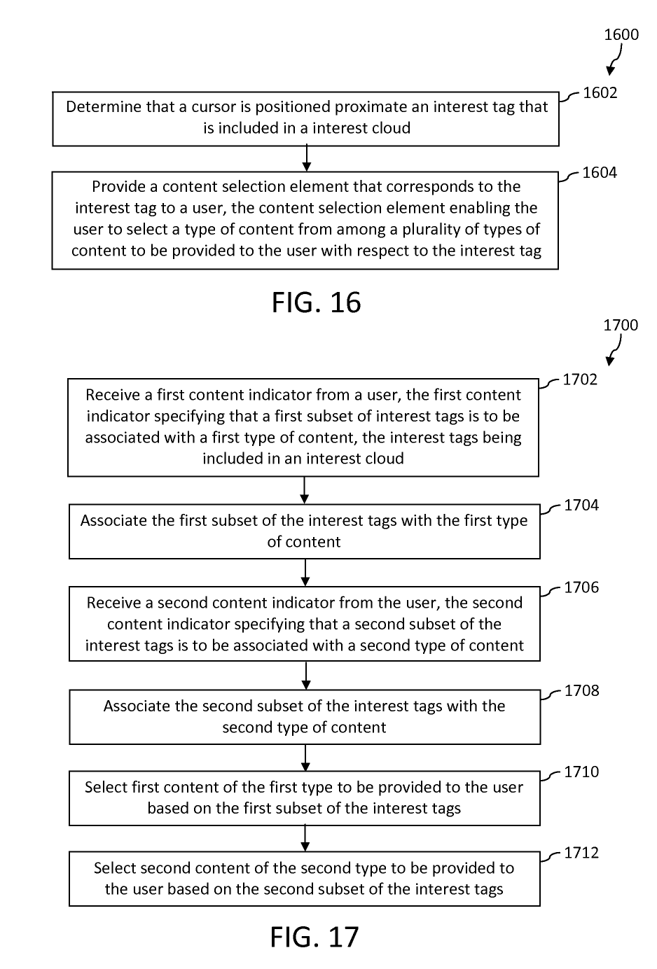

FIG. 16 depicts a flowchart 1600 of an example method of enabling a user to change a content attribute of an interest tag in accordance with an embodiment described herein. As shown in FIG. 16, the method of flowchart 1600 begins at step 1602. In step 1602, a determination is made that a cursor is positioned proximate an interest tag that is included in an interest cloud. In an example implementation, proximity module 2006 determines that the cursor is positioned proximate the interest tag. In some example embodiments, step 1602 need not necessarily be performed.

At step 1604, a content selection element that corresponds to the interest tag is provided to a user. The content selection element enables the user to select a type of content from among a plurality of types of content to be provided to the user with respect to the interest tag. In an example implementation, content selector 2004 provides the content selection element that corresponds to the interest tag to the user.

FIG. 17 depicts a flowchart 1700 of an example method of selecting content based on content attributes of interest tags in accordance with an embodiment described herein. As shown in FIG. 17, the method of flowchart 1700 begins at step 1702. In step 1702, a first content indicator is received from the user. The first content indicator specifies that a first subset of interest tags is to be associated with a first type of content. The interest tags are included in an interest cloud. In an example implementation, association module 2010 receives the first content indicator from the user.

At step 1704, the first subset of the interest tags is associated with the first type of content. Accordingly, it may be said that a content attribute of each tag in the first subset is set to specify the first type of content. In an example implementation, association module 2010 associates the first subset of the interest tags with the first type of content.

At step 1706, a second content indicator is received from the user. The second content indicator specifies that a second subset of the interest tags is to be associated with a second type of content. In an example implementation, association module 2010 receives the second content indicator from the user.

At step 1708, the second subset of the interest tags is associated with the second type of content. Accordingly, it may be said that a content attribute of each tag in the second subset is set to specify the second type of content. In an example implementation, association module 2010 associates the second subset of the interest tags with the second type of content.

At step 1710, first content of the first type is selected to be provided to the user based on the first subset of the interest tags. In an example implementation, content selector 2004 selects the first content of the first type to be provided to the user based on the first subset of the interest tags.

At step 1712, second content of the second type is selected to be provided to the user based on the second subset of the interest tags. In an example implementation, content selector 2004 selects the second content of the second type to be provided to the user based on the second subset of the interest tags.

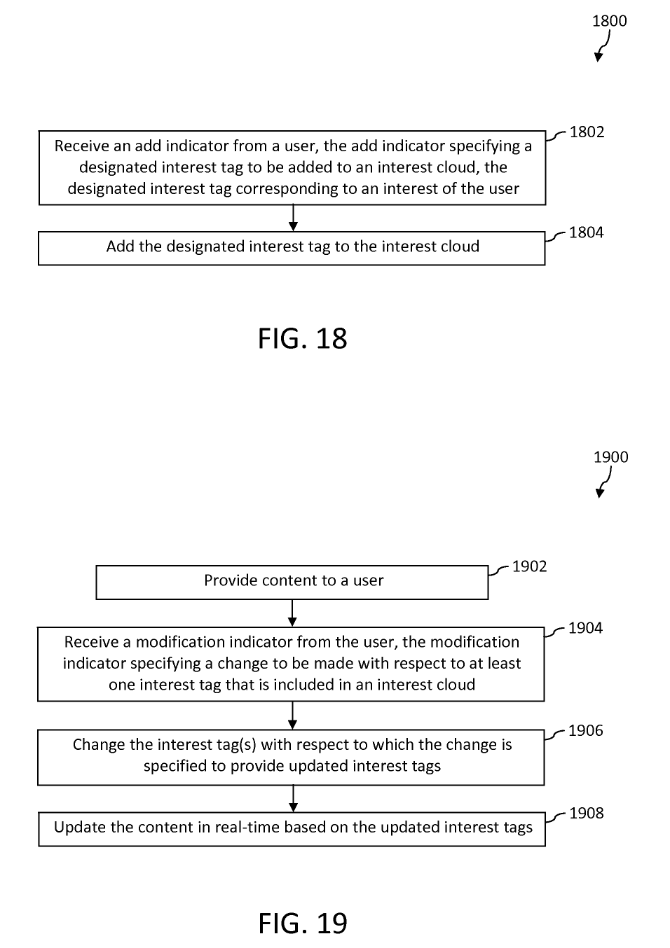

FIG. 18 depicts a flowchart 1800 of an example method of adding an interest tag to an interest could in accordance with an embodiment described herein. As shown in FIG. 18, the method of flowchart 1800 begins at step 1802. In step 1802, an add indicator is received from a user. The add indicator specifies a designated interest tag to be added to an interest cloud. The designated interest tag corresponds to an interest of the user. In an example implementation, cloud provider 2002 receives the add indicator from the user.

At step 1804, the designated interest tag is added to the interest cloud. In an example implementation, cloud provider 2002 adds the designated interest tag to the interest cloud.

FIG. 19 depicts a flowchart 1900 of an example method of updating content that is provided to a user in accordance with an embodiment described herein. As shown in FIG. 19, the method of flowchart 1900 begins at step 1902. In step 1902, content is provided to a user. In an example implementation, content provider 2012 provides the content to the user.

At step 1904, a modification indicator is received from the user. The modification indicator specifies a change to be made with respect to at least one interest tag that is included in an interest cloud. In an example implementation, cloud provider 2002 receives the modification indicator from the user.

At step 1906, the interest tag(s) with respect to which the change is specified are changed to provide updated interest tags. In an example implementation, cloud provider 2002 changes the interest tag(s) with respect to which the change is specified.

At step 1908, the content is updated in real-time based on the updated interest tags. In an example implementation, content provider 2012 updates the content in real-time based on the updated interest tags.

In an example embodiment, as the content is updated in real-time at step 1908, a cron job is run as a background process to aggregate more relevant content, which is not available for provision to the user in real-time. In another example embodiment, the cron job is run and the more relevant content is provided to the user in lieu of performing step 1908.

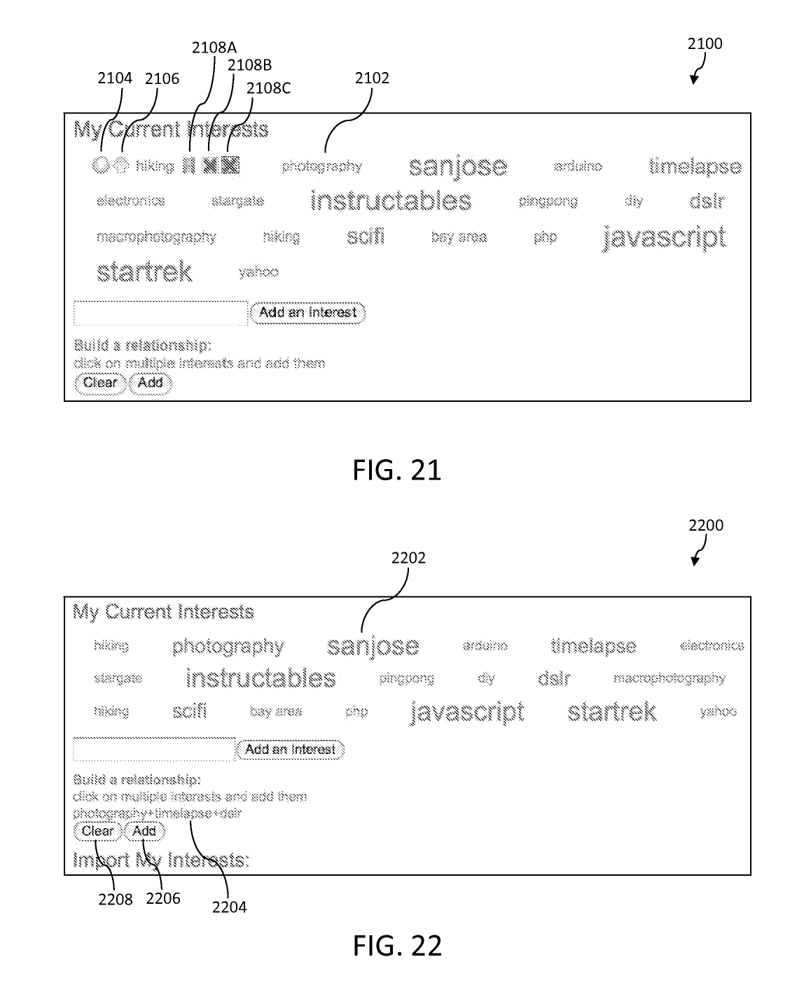

FIGS. 21-23 show other example interest clouds 2100, 2200, and 2300 in accordance with embodiments described herein. As shown in FIG. 21, interest cloud 2100 includes a plurality of interest tags 2102, one of which is labeled as “hiking”. The “hiking” interest tag is associated with priority indicators 2104 and 2106 and content indicators 2108A-2108C. Priority indicator 2104 is used for decreasing a priority of the “hiking” interest tag. Priority indicator 2106 is used for increasing the priority of the “hiking” interest tag. Priority indicator 2104 is shown as a circle that includes an “X”, indicating that the priority of the “hiking” interest tag cannot be decreased. For instance, the priority that is associated with the “hiking” interest tag in FIG. 21 may be the lowest priority in a range of priorities from which the user may select.

A font size of an interest tag may correspond to a priority of the interest tag. For instance, an interest tag having a relatively high priority may have a relatively large font; whereas, an interest tag having a relatively low priority may have a relatively small font. As shown in FIG. 21, the “hiking” interest tag has the smallest font size of those shown with respect to the interest tags 2102 in FIG. 21 to reflect that the “hiking” interest tag has the lowest priority.

Content indicators 2108A-2108C correspond to video content, image content, and news content, respectively. Content indicator 2108A specifies that the “hiking” interest tag is associated with video content, meaning that the “hiking” interest tag is to be taken into consideration for purposes of providing video content to the user. Content indicator 2108B is shown to include an “X”, indicating that the “hiking” interest tag is not associated with image content. Content indicator 2108C is also shown to include an “X”, indicating that the “hiking” interest tag is not associated with news content. Accordingly, the “hiking” interest tag is not to be taken into consideration for purposes of providing image content or news content to the user.

As shown in FIG. 22, interest cloud 2200 includes a plurality of interest tags 2202. A user may select two or more of the interest tags 2202 for creation of a cumulative interest tag that includes the selected interest tags. For example, text 2204 indicates that the user has selected “photography”, “timelapse”, and “dslr” interest tags. The user may select add button 2202 to add the cumulative interest tag of “photography+timelapse+dslr” to interest cloud 2206. Alternatively, the user may select clear button 2208 to erase text 2204. Upon erasing text 2204, the user may again select two or more of the interest tags 2202 for creation of a cumulative interest tag that includes the selected interest tags.

As shown in FIG. 23, interest cloud 2300 includes a plurality of interest tags 2302. The plurality of interest tags 2302 includes a cumulative interest tag 2306 that is a combination of the “photography”, “timelapse”, and “dslr” interest tags. For example, a user may select the “photography”, “timelapse”, and “dslr” interest tags and then select add button 2304 to add the “photography+timelapse+dslr” cumulative interest tag 2306 to interest cloud 2300. Cumulative interest tag 2306 is associated with a priority indicator 2310 and content indicators 2308A-2308C. Priority indicator 2310 may be selected by the user to decrease a priority of cumulative interest tag 2306. FIG. 23 does not show a priority indicator for increasing the priority of cumulative interest tag 2306. For example, the priority of cumulative interest tag 2306 may be the highest priority in a range of priorities from which the user may select. In accordance with this example, there is no need for a priority indicator that enables the user to increase the priority of cumulative interest tag 2306 unless the priority of cumulative interest tag 2306 is decreased to a priority that is less than the highest priority. Cumulative interest tag 2306 is shown to have the largest font size of those shown with respect to the interest tags 2302 in FIG. 23 to reflect that cumulative interest tag is associated with the highest priority.

FIG. 24 depicts a flowchart 2400 of an example method of adding a cumulative interest tag to an interest cloud in accordance with an embodiment described herein. As shown in FIG. 24, the method of flowchart 2400 begins at step 2402. In step 2402, a determination is made that a cursor is positioned proximate a first interest tag that is included in an interest cloud. In an example implementation, proximity module 2006 determines that the cursor is positioned proximate the first interest tag.

At step 2404, a recommendation element that corresponds to the first interest tag is provided to a user. The recommendation element recommends formation of a relationship between the first interest tag and a second interest tag that is included in the interest cloud. For example, the recommendation element may recommend that the first interest tag and the second interest tag be combined using a Boolean operator (e.g., an AND operator, an OR operator, etc.). In an example implementation, recommendation module 2014 provides the recommendation that corresponds to the first interest tag to the user.

At step 2406, a relationship indicator is received from the user. The relationship indicator specifies that the relationship is to be formed between the first interest tag and the second interest tag. In an example implementation, cloud provider 2014 receives the relationship indicator from the user.

At step 2408, a cumulative interest tag is added to the interest cloud. The cumulative interest tag includes the first interest tag and the second interest tag having the relationship that is specified by the relationship indicator. In an example implementation, cloud provider 2014 adds the cumulative interest tag to the interest cloud.

At step 2410, a designated priority is set to be greater than a first priority of the first interest tag based on the cumulative interest tag including the first interest tag and to be greater than a second priority of the second interest tag based on the cumulative interest tag including the second interest tag. In an example implementation, association module 2010 sets the designated priority to be greater than the first priority of the first interest tag and to be greater than the second priority of the second interest tag.

At step 2412, the designated priority is associated with the cumulative interest tag. In an example implementation, association module 2010 associates the designated priority with the cumulative interest tag.

In some example embodiments, one or more steps 2402, 2404, 2406, 2408, 2410, and/or 2412 of flowchart 2400 may not be performed. Moreover, steps in addition to or in lieu of steps 2402, 2404, 2406, 2408, 2410, and/or 2412 may be performed.

It will be recognized that interest cloud module 2000 may not include one or more of cloud provider 2002, content selector 2004, proximity module 2006, priority module 2008, association module 2010, content provider 2012, and/or recommendation module 2014. Furthermore, interest cloud module 2000 may include modules in addition to or in lieu of cloud provider 2002, content selector 2004, proximity module 2006, priority module 2008, association module 2010, content provider 2012, and/or recommendation module 2014.

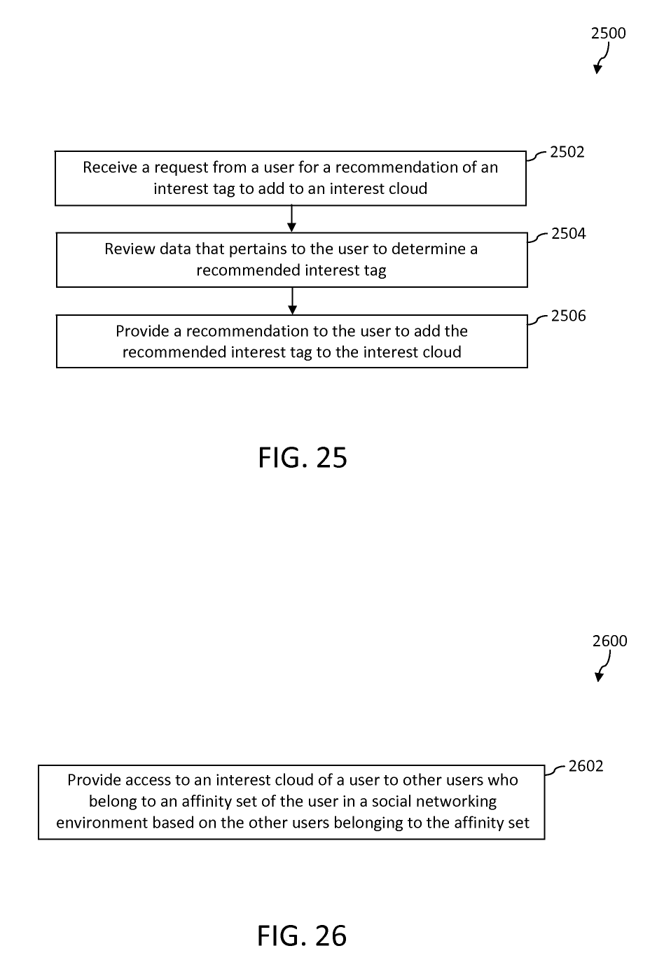

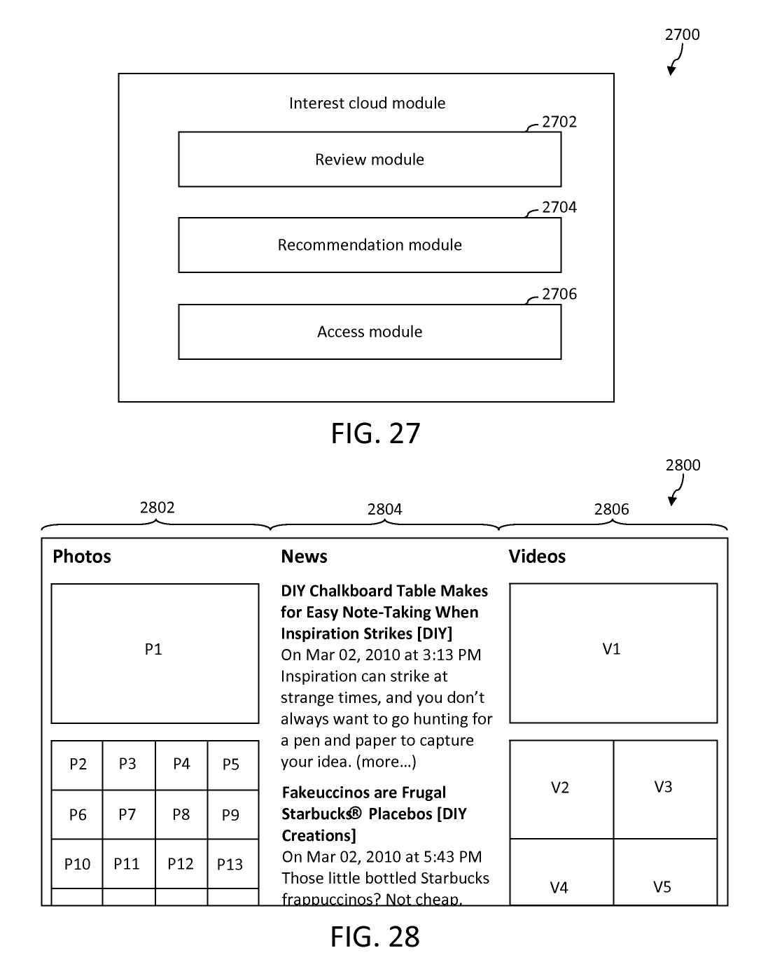

FIG. 25 depicts a flowchart 2500 of an example method of recommending an interest tag to a user in accordance with an embodiment described herein. FIG. 26 depicts a flowchart 2600 of an example method of providing access to an interest cloud in accordance with an embodiment described herein. Flowcharts 2500 and 2600 may be performed by interest cloud module 108 of computer system 100 shown in FIG. 1, for example. For illustrative purposes, flowcharts 2500 and 2600 are described with respect to an interest cloud module 2700 shown in FIG. 27, which is an example of an interest cloud module 108, according to an embodiment. As shown in FIG. 27, interest cloud module 2700 includes a review module 2702, a recommendation module 2704, and an access module 2706. Further structural and operational embodiments will be apparent to persons skilled in the relevant art(s) based on the discussion regarding flowcharts 2500 and 2600.

As shown in FIG. 25, the method of flowchart 2500 begins at step 2502. In step 2502, a request is received from a user for a recommendation of an interest tag to add to an interest cloud. In an example implementation, review module 2702 receives the request from the user. In some example embodiments, step 2502 need not necessarily be performed.

At step 2504, data that pertains to the user is reviewed to determine a recommended interest tag. In an example implementation, review module 2702 reviews the data that pertains to the user to determine the recommended interest tag.

At step 2506, a recommendation is provided to the user to add the recommended interest tag to the interest cloud. In an example implementation, recommendation module 2704 provides the recommendation to the user.

As shown in FIG. 26, the method of flowchart 2600 includes step 2602, in which access to an interest cloud of a user is provided to other users who belong to an affinity set of the user in a social networking environment based on the other users belonging to the affinity set. Such other users are often referred to as “connections” of the user. For example, an affinity set may be any group of persons, including a group of friends, business associates, players of a massively multiplayer online game, persons with a common interest, all users of a social network, application (“app”), or web site, or a subgroup thereof. A user may belong to any number of affinity sets. In an example implementation, access module 2706 provides access to the interest cloud to the other users who belong to the affinity set of the user.

It will be recognized that interest cloud module 2700 may not include one or more of review module 2702, recommendation module 2704, and/or access module 2706. Furthermore, interest cloud module 2700 may include modules in addition to or in lieu of review module 2702, recommendation module 2704, and/or access module 2706.

FIG. 28 shows example content 2800 that may be provided to a user in accordance with an embodiment described herein. As shown in FIG. 28, content 2800 includes three types of content: image content 2802, news content 2804, and video content 2806. Interest tags that are associated with image content may be taken into consideration for selecting image content 2802; interest tags that are associated with news content may be taken into consideration for selecting news content 2804; and interest tags that are associated with video content may be taken into consideration for selecting video content 2806. Each of image content 2802, news content 2804, and video content 2806 may be received from a respective single source or aggregated from a respective plurality of sources. Each single source and/or plurality of sources may be selected by the user.

Image content 2802 includes a plurality of images. Images P1-P13 of the plurality of images are shown in FIG. 28 for illustrative purposes. News content 2804 includes a plurality of news articles. Each article is displayed as a title and corresponding introductory text for illustrative purposes, though it will be recognized that each article may be displayed in any suitable manner. The user may select the title of an article, a graphical interface element that is associated with the article, introductory text of the article, etc. to see the entire article. Alternatively, each article in news content 2804 may be displayed as an entire article. Video content 2806 includes a plurality of videos. Videos V1-V5 of the plurality of videos are shown in FIG. 28 for illustrative purposes.

Images in addition to images P1-P13, news articles in addition to those shown in FIG. 28, and/or videos in addition to videos V1-V5 may be viewed by using a scrolling element that is associated with content 2800 or clicking a graphical interface element, such as a “next” button.

Image content 2802, news content 2804, and video content 2806 are provided in respective columns in FIG. 28 for illustrative purposes and are not intended to be limiting. Different types of content may be provided in any suitable configuration.

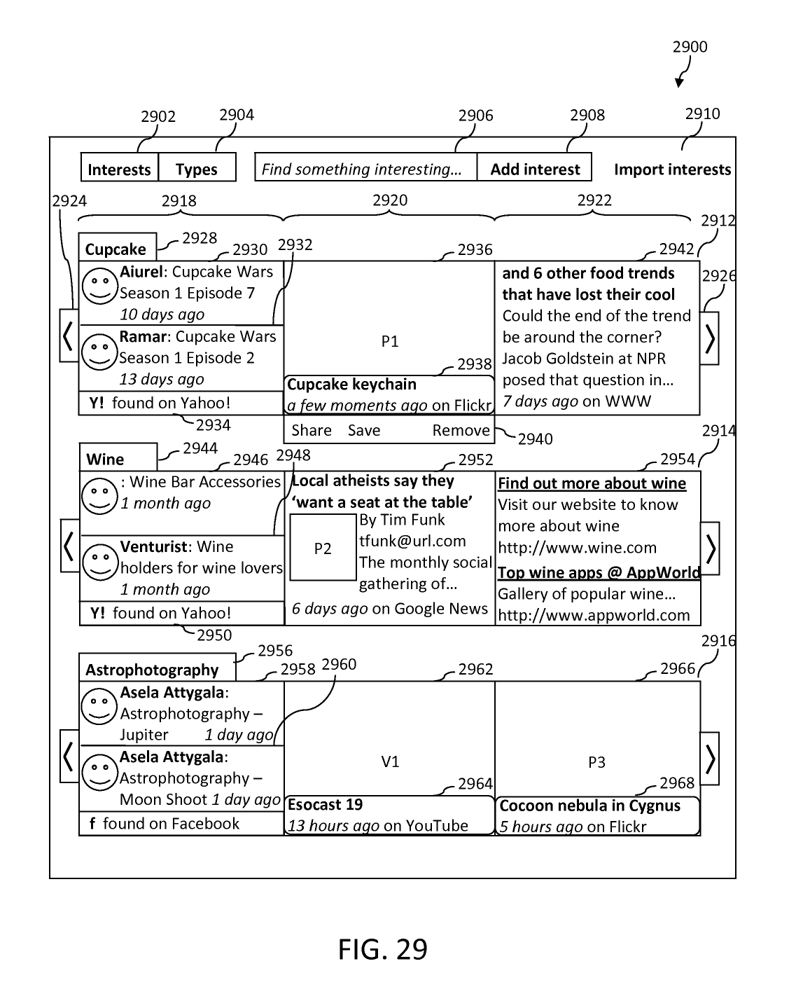

FIGS. 29-31 depict example pages 2900, 3000, and 3100 in accordance with embodiments described herein. As shown in FIG. 29, page 2900 includes an interest button 2902, a types button 2904, an entry element 2906, an add button 2908, an import button 2910, and interface elements 2912, 2914, and 2916. A user may select the interests button 2902 to gain access to a page (e.g., a web page) in which the user may modify interest tags (and/or attributes thereof) that are included in an interest cloud of the user. For instance, an attribute of an interest tag may be a priority of the interest tag, type(s) of content associated with the interest tag, etc. The user may select the types button 2904 to change the types of content that may be provided to the user without regard to any particular interest tag. For example, the user may designate that only images are to be provided to the user. In another example, the user may designate that images and social update elements are not to be provided to the user. In yet another example, the user may designate that only videos and news articles are to be provided to the user.

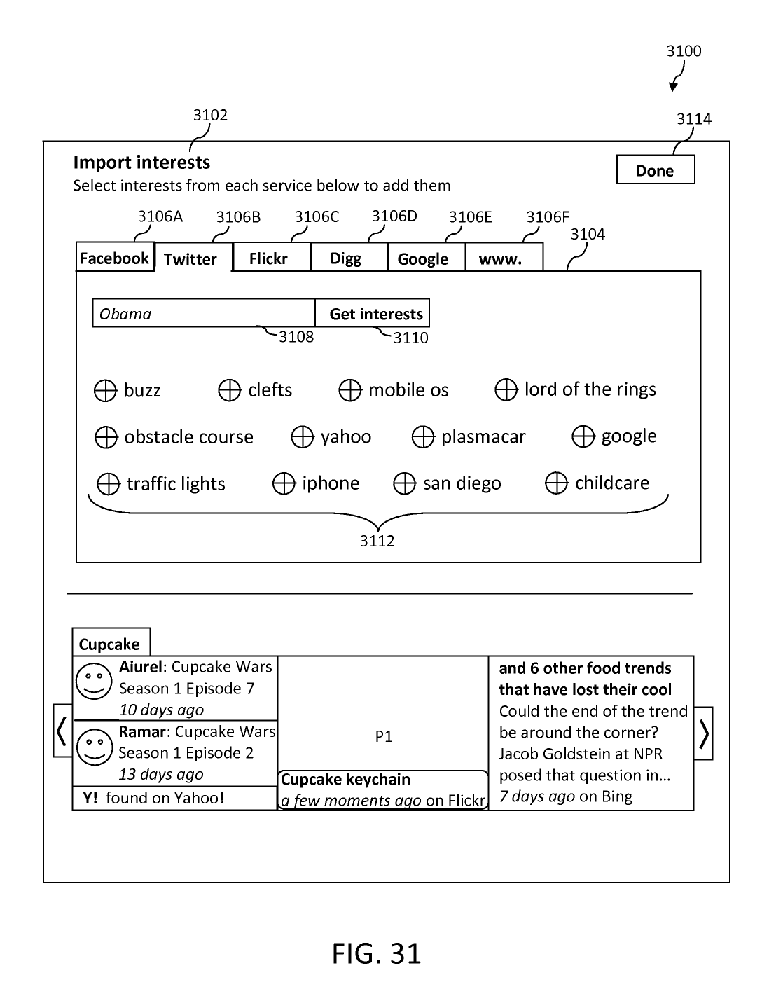

A user may type an interest into the entry element 2906 and select the add button 2908 to add an interest tag to the user's interest cloud. A user may select the import button 2910 to gain access to a page, such as page 3100 described below with reference to FIG. 31, to import interest tags from source(s) and to select a subset of the interest tags upon which content that is provided to the user is based.

Interface element 2912 includes first content that is based on a “cupcake” interest tag, as indicated by tab 2928. Interface element 2914 includes second content that is based on a “wine” interest tag, as indicated by tab 2944. Interface element 2916 includes third content that is based on an “astrophotography” interest tag, as indicated by tab 2956. Each of the first, second, and third content is based on an interest tag that corresponds to a single interest of the user for illustrative purposes and is not intended to be limiting. For example, content (e.g., first, second, and/or third content) may be based on a cumulative interest tag, which corresponds to multiple interests of the user.

Each of the interface elements 2912, 2914, and 2916 includes browsing elements 2924 and 2926, which enable the user to browse through the first, second, and third content, respectively. Accordingly, interface elements 2912, 2914, and 2916 are referred to as browser elements. Each browsing element 2924 enables the user to browse to the left through respective content, and each browsing element 2926 enables the user to browse to the right through the respective content. Each of the first, second, and third content is arranged in columns 2918, 2920, and 2922 for illustrative purposes and is not intended to be limiting. It will be recognized that the first, second, and third content may be arranged in any suitable manner.

The first content in column 2918 of interface element 2912 includes links 2930 and 2932 to respective episodes of a television show entitled “Cupcake Wars”. Link 2930 is indicated to have been posted ten days ago. Link 2932 is indicated to have been posted thirteen days ago. Source indicator 2934 indicates that links 2930 and 2932 are provided from the Yahoo!® network. For example, links 2930 and 2932 may be provided as a search result based on a search query of “cupcake” with respect to a Yahoo!® search engine. The first content in column 2920 of interface element 2912 includes a picture P1 and a caption 2938 that provides a title of the picture P1 and indicates that the picture P1 was posted a few moments ago on Flickr®. An action element 2940 includes a share indicator, a save indicator, and a remove indicator. The user may select (e.g., click on) the share, save, and/or remove indicator to respectively share the picture with at least one person, save the picture P1, and/or remove the picture P1 from the first content. The first content in column 2922 of interface element 2912 includes a link 2942 to a story regarding food trends that is provided from the World Wide Web without regard to any particular network or uniform resource identifier (URI) to indicate that a source may be the World Wide Web. Link 2942 is shown to have been posted seven days ago for illustrative purposes.

The first content that is provided in interface element 2912 is shown to be aggregated from at least three different sources (i.e., Yahoo!®, Flickr®, and Associated Content®) for illustrative purposes and is not intended to be limiting. It will be recognized that content that is provided in an interface element (e.g., the first content in interface element 2912) may be provided from a single source.

The second content in column 2918 of interface element 2914 includes links 2946 and 2948 to respective articles about wine-related devices. Source indicator 2950 indicates that links 2946 and 2948 are provided from the Yahoo!® network. The second content in columns 2920 of interface element 2914 includes a link to an article, along with a picture P2 that pertains to the article, that was posted on Google® News six days ago. The second content in column 2954 includes two contextual advertisements that pertain to wine. The first contextual advertisement links to a web page at a URL of http://www.wine.com. The second contextual advertisement links to a web page at a URL of http://www.appworld.com.

The third content in column 2918 of interface element 2916 includes social update elements 2958 and 2960 from a social update stream of a user named Asela Attygala on Facebook®. The third content in column 2920 of interface element 2916 includes a video V1 and a caption 2964 that provides a title of the video V1 and indicates that the video V1 was posted thirteen hours ago on YouTube®. The third content in column 2922 of interface element 2916 includes a picture P3 and a caption 2968 that provides a title of the picture P3 and indicates that the picture P3 was posted five hours ago on Flickr®.

The example content elements and sources described with respect to FIG. 29 are provided for illustrative purposes and are not intended to be limiting. Each of the first, second, and third content may include any suitable content elements from any suitable one or more sources. Moreover, page 2900 is shown to include three interface elements 2912, 2914, and 2916 for illustrative purposes. It will be recognized that a page (e.g., page 2900) may include any number of interface elements.

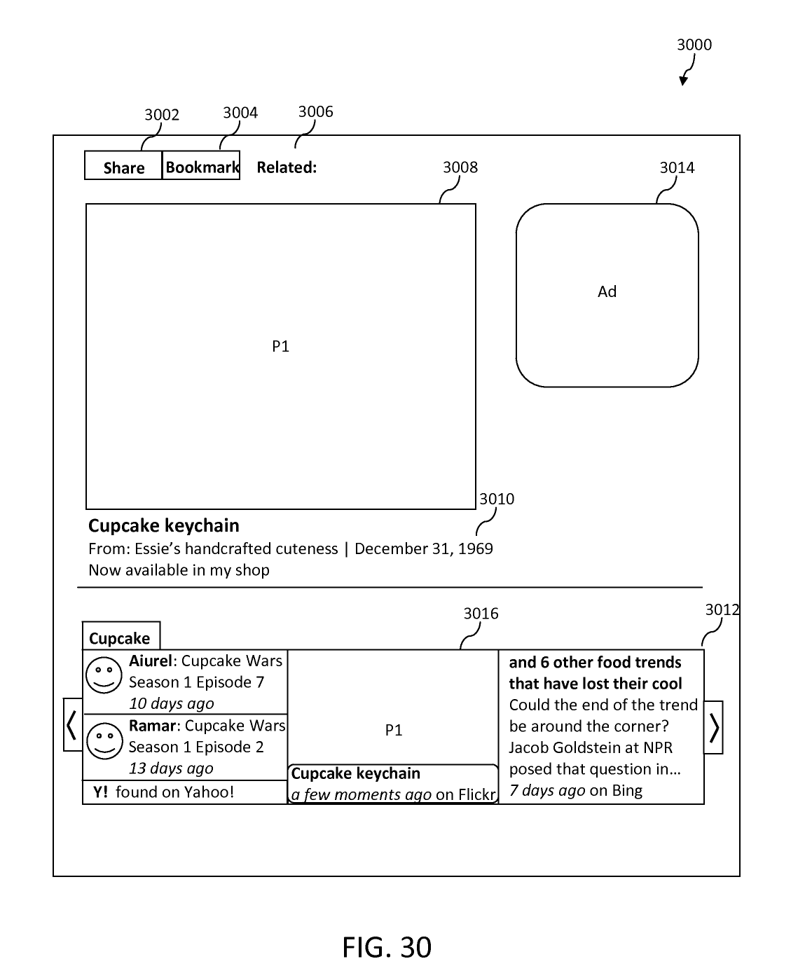

FIG. 30 illustrates a page 3000 that includes a browser element 3012 and a designated content element 3008. Browser element 3012 enables a user to browse through content that includes link 3016. Link 3016 is linked to designated content element 3008. When the user selects link 3016, designated content element 3008 is provided along with the browser element 3012 in page 3000, as shown in FIG. 30. Page 3000 further includes a caption 3010 to provide information regarding designated content element 3008. Page 3000 is shown to include an advertisement 3014 that is based on interest tag(s) upon which the content in browser element 3012 is based. Page 3000 further includes a share button that enables the user to share designated content element 3008 with at least one person, a bookmark button 3004 that enables the user to bookmark designated content element 3008, and a related indicator 3006 that enables the user to obtain content that is related to designated content element 3008. For example, the obtained content may be included in an interface element (e.g., a second browser element) that is different from browser element 3012 in page 3000. In accordance with this example, the obtained content may be based on key terms that are associated with designated content element 3008.

FIG. 31 illustrates a page 3100 in which a user may import interest tags from source(s) and select a subset of the interest tags upon which content that is provided to the user is based. As shown in FIG. 31, a heading 3102 indicates that page 3100 is for importing interest tags and that the user is to select interest tags from each of a plurality of sources 3106A-3106F in order for the content that is provided to the user to be based on those interest tags. The plurality of sources is shown to include Facebook® 3106A, Twitter® 3106B, Flickr® 3106C, Digg™ 3106D, Google® 3106E, and the World Wide Web 3106F.

Twitter 3106B is shown to be selected by the user to reveal an entry element 3108 and a “Get interests” button 3110. A user may type a username (e.g., Obama in this example) into the entry element 3108 and select the “Get interests” button 3110 to populate window 3104 with interest tags 3112 that are associated with content from the user's Twitter® account. For instance, the interest tags 3112 may be included in a Twitter® social update stream of the user. The user may select any one or more of the interest tags 3112. Alternatively, the user may not select any of the interest tags 3112. Regardless, the user may select another of the plurality of sources 3106A-3106F to view interest tags that are based on content that is retrieved therefrom. Once the user has finished selecting interest tags, the user may select the done button 3114 to initiate the provision of content to the user based on the interest tags that were selected by the user.

It should be noted that interest cloud module 108 of FIG. 1 may include receipt module 1202, retrieval module 1204, cloud generator 1206, content provider 1208, selection determination module 1210, update module 1212, recommendation module 1214, assignment module 1216, and/or filter module 1218 of FIG. 12; cloud provider 2002, content selector 2004, proximity module 2006, priority module 2008, association module 2010, content provider 2012, and/or recommendation module 2014 of FIG. 20; review module 2702, recommendation module 2704, and/or access module 2706 of FIG. 27; or any portion or combination thereof, for example, though the scope of the embodiments is not limited in this respect.

Interest cloud module 108, receipt module 1202, retrieval module 1204, cloud generator 1206, content provider 1208, selection determination module 1210, update module 1212, recommendation module 1214, assignment module 1216, filter module 1218, cloud provider 2002, content selector 2004, proximity module 2006, priority module 2008, association module 2010, content provider 2012, recommendation module 2014, review module 2702, recommendation module 2704, and access module 2706 may be implemented in hardware, software, firmware, or any combination thereof.

For example, interest cloud module 108, receipt module 1202, retrieval module 1204, cloud generator 1206, content provider 1208, selection determination module 1210, update module 1212, recommendation module 1214, assignment module 1216, filter module 1218, cloud provider 2002, content selector 2004, proximity module 2006, priority module 2008, association module 2010, content provider 2012, recommendation module 2014, review module 2702, recommendation module 2704, and/or access module 2706 may be implemented as computer program code configured to be executed in one or more processors.

In another example, interest cloud module 108, receipt module 1202, retrieval module 1204, cloud generator 1206, content provider 1208, selection determination module 1210, update module 1212, recommendation module 1214, assignment module 1216, filter module 1218, cloud provider 2002, content selector 2004, proximity module 2006, priority module 2008, association module 2010, content provider 2012, recommendation module 2014, review module 2702, recommendation module 2704, and/or access module 2706 may be implemented as hardware logic/electrical circuitry.

### IV. Example Computer Implementation

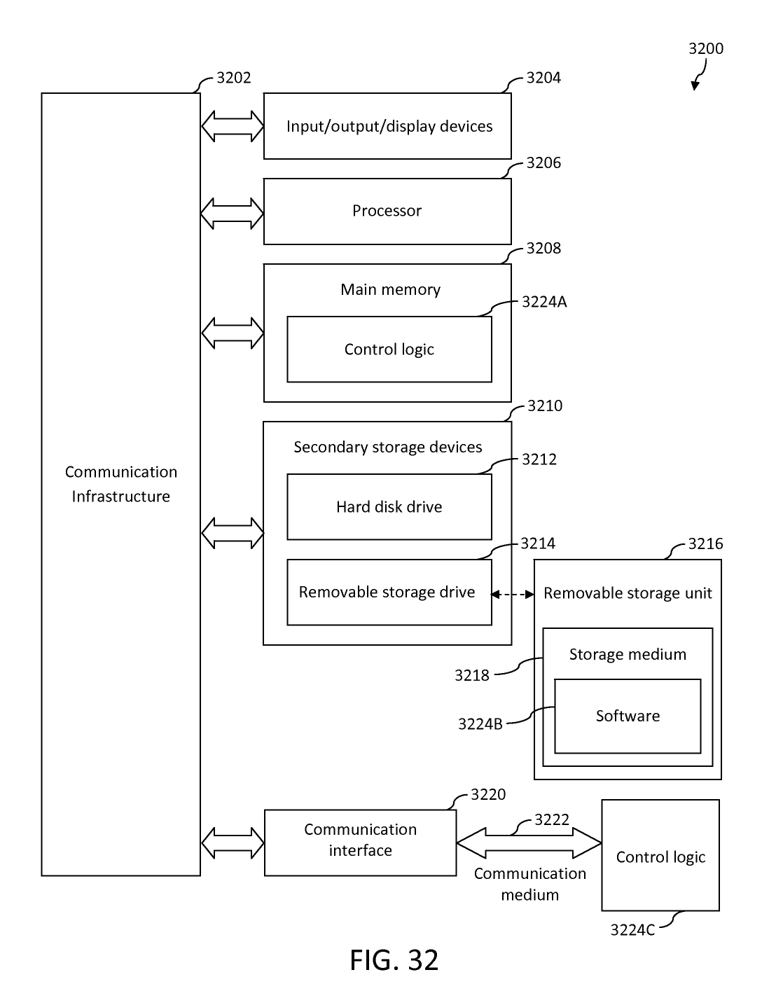

The embodiments described herein, including systems, methods/processes, and/or apparatuses, may be implemented using well known servers/computers, such as computer 3200 shown in FIG. 32. For example, elements of example computer system 100, including any of the user systems 102A-102M and any of the servers 106A-106N depicted in FIG. 1 and elements thereof (including interest cloud module 108 depicted in FIGS. 1, 12, 20, and 27 and elements thereof), and each of the steps of flowcharts 200, 300, 400, 500, 600, 700, 800, 900, 1000, 1100, 1400, 1500, 1600, 1700, 1800, 1900, 2400, 2500, and 2600 depicted in respective FIGS. 2-11, 14-19, and 24-26 can each be implemented using one or more computers 3200.

Computer 3200 can be any commercially available and well known computer capable of performing the functions described herein, such as computers available from International Business Machines, Apple, Sun, HP, Dell, Cray, etc. Computer 3200 may be any type of computer, including a desktop computer, a server, etc.

As shown in FIG. 32, computer 3200 includes one or more processors (e.g., central processing units (CPUs)), such as processor 3206. Processor 3206 may include interest cloud module 108 of FIG. 1; receipt module 1202, retrieval module 1204, cloud generator 1206, content provider 1208, selection determination module 1210, update module 1212, recommendation module 1214, assignment module 1216, and/or filter module 1218 of FIG. 12; cloud provider 2002, content selector 2004, proximity module 2006, priority module 2008, association module 2010, content provider 2012, and/or recommendation module 2014 of FIG. 20; review module 2702, recommendation module 2704, and/or access module 2706 of FIG. 27; or any portion or combination thereof, for example, though the scope of the embodiments is not limited in this respect. Processor 3206 is connected to a communication infrastructure 3202, such as a communication bus. In some embodiments, processor 3206 can simultaneously operate multiple computing threads.

Computer 3200 also includes a primary or main memory 3208, such as a random access memory (RAM). Main memory has stored therein control logic 3224A (computer software), and data.

Computer 3200 also includes one or more secondary storage devices 3210. Secondary storage devices 3210 include, for example, a hard disk drive 3212 and/or a removable storage device or drive 3214, as well as other types of storage devices, such as memory cards and memory sticks. For instance, computer 3200 may include an industry standard interface, such as a universal serial bus (USB) interface for interfacing with devices such as a memory stick. Removable storage drive 3214 represents a floppy disk drive, a magnetic tape drive, a compact disk drive, an optical storage device, tape backup, etc.

Removable storage drive 3214 interacts with a removable storage unit 3216.

Removable storage unit 3216 includes a computer useable or readable storage medium 3218 having stored therein computer software 3224B (control logic) and/or data. Removable storage unit 3216 represents a floppy disk, magnetic tape, compact disc (CD), digital versatile disc (DVD), Blue-ray disc, optical storage disk, memory stick, memory card, or any other computer data storage device. Removable storage drive 3214 reads from and/or writes to removable storage unit 3216 in a well known manner.

Computer 3200 also includes input/output/display devices 3204, such as monitors, keyboards, pointing devices, etc.

Computer 3200 further includes a communication or network interface 3220. Communication interface 3220 enables computer 3200 to communicate with remote devices. For example, communication interface 3220 allows computer 3200 to communicate over communication networks or mediums 3222 (representing a form of a computer useable or readable medium), such as local area networks (LANs), wide area networks (WANs), the Internet, etc. Network interface 3220 may interface with remote sites or networks via wired or wireless connections. Examples of communication interface 3222 include but are not limited to a modem, a network interface card (e.g., an Ethernet card), a communication port, a Personal Computer Memory Card International Association (PCMCIA) card, etc.

Control logic 3224C may be transmitted to and from computer 3200 via the communication medium 3222.

Any apparatus or manufacture comprising a computer useable or readable medium having control logic (software) stored therein is referred to herein as a computer program product or program storage device. This includes, but is not limited to, computer 3200, main memory 3208, secondary storage devices 3210, and removable storage unit 3216. Such computer program products, having control logic stored therein that, when executed by one or more data processing devices, cause such data processing devices to operate as described herein, represent embodiments of the invention.

For example, each of the elements of example servers 106A-106N, including interest cloud module 108 of FIG. 1; receipt module 1202, retrieval module 1204, cloud generator 1206, content provider 1208, selection determination module 1210, update module 1212, recommendation module 1214, assignment module 1216, and filter module 1218, each depicted in FIG. 12; cloud provider 2002, content selector 2004, proximity module 2006, priority module 2008, association module 2010, content provider 2012, and recommendation module 2014, each depicted in FIG. 20; review module 2702, recommendation module 2704, and access module 2706, each depicted in FIG. 27; and each of the steps of flowcharts 200, 300, 400, 500, 600, 700, 800, 900, 1000, 1100, 1400, 1500, 1600, 1700, 1800, 1900, 2400, 2500, and 2600 depicted in respective FIGS. 2-11, 14-19, and 24-26 can be implemented as control logic that may be stored on a computer useable medium or computer readable medium, which can be executed by one or more processors to operate as described herein.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
retrieving first content from one or more first sources;
generating an interest cloud that includes a plurality of interest tags that corresponds to a plurality of respective key terms that are associated with the first content; and
providing second content that includes a plurality of content elements to a user based on a subset of the plurality of interest tags that is selected by the user, the second content being aggregated from a plurality of second sources that is selected by the user, each interest tag in the subset corresponding to a respective interest of the user.

2. The method of claim 1, wherein retrieving the first content comprises:
retrieving the first content which includes a second plurality of content elements;
wherein the method further comprises:
receiving a content indicator that specifies that a designated content element of the second plurality of content elements is selected by the user; and wherein generating the interest cloud comprises:
generating the interest cloud to include the plurality of interest tags that corresponds to the plurality of respective key terms that are associated with the designated content element in response to receiving the content indicator.

3. The method of claim 1, further comprising:
receiving a source indicator that specifies that the one or more first sources are selected by the user;
wherein retrieving the first content comprises:
retrieving the first content in response to receiving the source indicator.

4. The method of claim 1, further comprising:
receiving a selection indicator that specifies that a link that is included in the second content is selected by the user; and
providing a designated content element and a browser element in a common page in response to receiving the selection indicator;
wherein the link links to the designated content element; and
wherein the browser element enables the user to browse through the plurality of content elements that are included in the second content.

5. The method of claim 1, further comprising:
assigning a first priority to a first portion of the plurality of content elements, each content element in the first portion being associated with at least one affinity set of the user; and
assigning a second priority that is less than the first priority to a second portion of the plurality of content elements, each content element in the second portion not being associated with at least one affinity set of the user;
wherein providing the second content comprises:
providing the first portion of the plurality of content elements to the user before providing the second portion of the plurality of content elements to the user based on the second priority being less than the first priority.

6. The method of claim 1, wherein providing the second content comprises:
providing a first browser element in a page, the first browser element enabling the user to browse through the plurality of content elements; and
providing a second browser element that is different from the first browser element in the page, the second browser element enabling the user to browse through a first portion of the plurality of content elements that is associated with at least one affinity set of the user but not a second portion of the plurality of content elements that is not associated with at least one affinity set of the user.

7. The method of claim 1, further comprising:
receiving a content indicator that specifies one or more designated types of content to be included in the second content;
wherein providing the second content comprises:
providing the second content that includes the plurality of content elements in response to receiving the content indicator, each of the plurality of content elements being associated with at least one of the one or more designated types of content.

8. The method of claim 1, further comprising:
receiving a content indicator that specifies one or more designated types of content to not be included in the second content;
wherein providing the second content comprises:
providing the second content that includes the plurality of content elements in response to receiving the content indicator, each of the plurality of content elements not being associated with at least one of the one or more designated types of content.

9. The method of claim 1, wherein the second content is aggregated from the plurality of second sources that includes a plurality of social networks of which the user is a member.

10. The method of claim 1, wherein providing the second content comprises:
providing the second content to the user further based on demographic information regarding the user.

11. The method of claim 1, wherein providing the second content comprises:
providing the second content to the user further based on historical activity of the user with respect to at least one social network.

12. The method of claim 1, wherein the second content is aggregated from a plurality of content streams that is received from the plurality of respective second sources, each content stream including most popular content elements that correspond to the subset of the plurality of interest tags with respect to the respective second source.

13. A method comprising:
retrieving first content from one or more first sources;
generating an interest cloud that includes a plurality of interest tags that corresponds to a plurality of respective key terms that are associated with the first content; and
providing second content that includes a plurality of content streams to a user based on a subset of the plurality of interest tags that is selected by the user, each content stream being received from a respective source of a plurality of second sources that is selected by the user, the plurality of content streams being provided to the user in a plurality of respective browser elements in a common page, each browser element enabling the user to browse through the respective content stream, each interest tag in the subset corresponding to a respective interest of the user.

14. The method of claim 13, wherein retrieving the first content comprises:
retrieving the first content which includes a plurality of content elements;
wherein the method further comprises:
receiving a content indicator that specifies that a designated content element of the plurality of content elements is selected by the user; and wherein generating the interest cloud comprises:
generating the interest cloud to include the plurality of interest tags that corresponds to the plurality of respective key terms that are associated with the designated content element in response to receiving the content indicator.

15. The method of claim 13, further comprising:
receiving a source indicator that specifies that the one or more first sources are selected by the user;
wherein retrieving the first content comprises:
retrieving the first content in response to receiving the source indicator.

16. The method of claim 13, further comprising:
receiving a selection indicator that specifies that a link that is included in a designated content stream of the plurality of content streams is selected by the user; and
providing a designated content element to which the link links and the browser element in which the designated content stream is provided in a common page in response to receiving the selection indicator.

17. The method of claim 13, wherein the plurality of content streams is received from the respective plurality of second sources that includes a plurality of social networks of which the user is a member.

18. The method of claim 13, wherein providing the second content comprises:
providing the second content to the user further based on at least one of demographic information regarding the user or historical activity of the user with respect to at least one social network.

19. The method of claim 13, wherein each content stream includes most popular content elements that correspond to the subset of the plurality of interest tags with respect to the second source from which that content stream is received.

20. A system comprising:
a retrieval module configured to retrieve first content from one or more first sources;
a cloud generator configured to generate an interest cloud that includes a plurality of interest tags that corresponds to a plurality of respective key terms that are associated with the first content; and
a content provider configured to provide second content that includes a plurality of content elements to a user based on a subset of the plurality of interest tags that is selected by the user, the second content being aggregated from a plurality of second sources that is selected by the user, each interest tag in the subset corresponding to a respective interest of the user.
